(19) United States
(12) Patent Application Publication
(10) Pub. No.: US 2021/0115293 A1
(43) Pub. Date: Apr. 22, 2021

(54) Coatings for Textured 3D-Printed Substrates

(71) Applicant: PRC-DeSoto International, Inc., Sylmar, CA (US)

(72) Inventors: Nadine D. Kraut, Glenshaw, PA (US); John T. Roman, West Mifflin, PA (US); Cynthia Kutchko, Pittsburgh, PA (US)

(73) Assignee: PRC-DeSoto International, Inc., Sylmar, CA (US)

(21) Appl. No.: 17/046,696

(22) PCT Filed: Apr. 9, 2019
(86) PCT No.: PCT/US2019/026672

§ 371 Date: Oct. 9, 2020

Related U.S. Application Data
(60) Provisional application No. 62/655,145, filed on Apr. 9, 2018.

(51) Int. Cl. C09D 175/04; C09D 163/00

(52) U.S. Cl. CPC C09D 175/04; B33Y 80/00; C09D 163/00

(57) ABSTRACT

Coating systems are used to visually hide low-profile surface features and to establish the optical properties of high profile surface features. The coating systems are useful in hiding build lines on the surface of articles fabricated using three-dimensional printing. Using the coating systems, the optical properties of intentional surface features such as patterns and textures can be modified to achieve a desired optical effect.

This application claims priority under 35 U.S.C. § 119(e) to U.S. Provisional Application No. 62/655,145 filed on Apr. 9, 2018, which is incorporated by reference in its entirety.

### FIELD

The disclosure relates to coatings for use with surfaces fabricated using additive manufacturing. The coatings can be used to visually hide surface features and to accentuate surface features.

### BACKGROUND

In an additive three-dimensional fabrication system, a physical object can be realized from a digital model by depositing successive layers of a build material that accumulates to provide a desired form. Certain additive techniques render each layer as a single, continuous path of an extruded material, typically completing a layer of the object in an x-y plane and then stepping to a next z position (or height) for each subsequent cross-sectional plane, all under computer control.

Techniques such as partial stepping or micro-step driving have been devised to increase spatial resolution for stepper motors typically used to control x-y positioning in such additive techniques. However, there remains a need for additive fabrication techniques that permit independent application of surface texture and other surface features, in particular small or sub-pixel features, to a model during fabrication.

As a result of the fabrication process, print or build lines will be evident between successive build layers. Various methods can be used to remove the print lines including surface abrasion methods and deposition of an exterior film or coating that completely covers the print lines.

Additive three-dimensional fabrication methods have been developed to impart a texture to a surface of a printed article. In such articles it can be desirable to visually hide the print lines while maintaining an intentional surface texture. For other printed articles it can be desirable to accentuate the intentional surface features to emphasize certain visual effects.

### SUMMARY

According to the present invention coated articles comprise: (a) an article comprising a surface, wherein, the surface comprises a plurality of low-profile features; and the plurality of low-profile features has a surface area roughness from 10 μm to 200 μm; and (b) a coating system overlying the surface, wherein the coating system comprises one or more coating layers, wherein the coated surface has a surface area roughness less than 10 μm.

According to the present invention methods of visually hiding a plurality of low-profile features on a surface of an article, comprise applying a coating system onto the surface to provide a coated surface, wherein, the coating system comprises one or more coating layers; and the coated surface has a surface area roughness less than 10 μm.

According to the present invention methods of accentuating a plurality of intentional topographical features on a surface of an article, wherein the surface comprises a plurality of low-profile features comprise applying a coating system onto the surface to provide a coated surface, wherein the low-profile features are not visually apparent on the coated surface.

### BRIEF DESCRIPTION OF THE DRAWINGS

The drawings described herein are for illustration purposes only. The drawings are not intended to limit the scope of the present disclosure.

FIG. 1 shows a printed surface having a leather-textured surface having a surface coating.

FIG. 2 shows a printed surface having a leather-textured surface having a surface coating.

FIG. 2 shows a printed surface having a leather-textured surface having a surface coating.

FIG. 4 shows a printed surface having a leather-textured surface having a surface coating.

FIG. 5 shows a printed test panel having a wood grain finish. The test panel was coated with a layer containing Andaro® red special-effects pigment. The right half of the test panel includes a top clearcoat layer and the left half includes a top matte-finish layer.

FIG. 6 shows printed a test panel having various textured surfaces. The upper half of the panel included a multi-layer coating consisting of a 2K (two-part) urethane-based primer, a sealer (ECS25), a basecoat (EHPT407), and a D8115 matte-finish topcoat. The lower half of the test panel was coated with a multilayer coating system that included a 2K urethane primer, an interior gray basecoat, a SHPT407 coating, and a D8115 matte-finish topcoat.

FIG. 7 shows a printed test panel having various textured surfaces. The upper half of the test panel was coated with a 2K urethane-based primer, a sealer (ECS25), an interior gray mid-coat, and a D8115 matte-finish topcoat. The lower half of the test panel was coated with a 2K urethane-based primer, a sealer (ECS25), a mid-coat containing a special-effects pigment Crystallance® smoking gun; Vibrance Collection®), and a DC4000 clearcoat.

FIG. 8 shows a printed test panel having various textured surfaces. The upper half of the test panel was coated with a 2K urethane-based primer (ECP15), a basecoat (ECS25), a Ruby-Red mid-coat, and a D8115 matte topcoat. The lower half of the test panel was coated with a 2K urethane-based primer, a sealer (ECS25), a Ruby Red mid-coat, a mid-coat containing a special effects pigment (Red Vibrance®), and a DC4000 clearcoat.

FIG. 9 shows printed test panel having various textured surfaces. The test panel was coated with a 2K urethane-based primer, a sealer (ECS25), an EHP T407 basecoat, and either a DC4000 clearcoat (upper half) or a D8115 matte topcoat (lower half).

FIG. 10 shows a printed textured test panel coated with a four-layer automotive refinish coating system.

FIG. 11 shows test panels coated with a soft-touch coating layer.

FIGS. 12A-12F show the topography of (12A)/(12B) an as-fabricated polycarbonate/ABS printed test panel; (12C)/(12D) the printed test panel with a 25 μm thick coating of a 2K urethane primer, and (12E)/(12F) the printed test panel with a 50 μm- to 62.5 μm-thick coating of a 2K epoxy primer. FIGS. 12A, 12C, and 12E show the topographical profile as measured using a confocal imaging system, with the numbers indicating the surface area roughness. FIGS. 12B, 12D, and 12F show photographs of the corresponding surfaces.

FIGS. 13A-13F show the topography of (1) an as-fabricated Ultem® 9085 printed test panel (13A)/(13B); (2) the printed test panel with a 25 μm-thick coating of a 2K urethane primer (13C)/(13D); and (3) the printed test panel with a 50 μm- to 62.5 μm thick coating of a 2K epoxy primer (13E)/(13F). FIGS. 13A, 13C, and 13E show the topographical profile as measured using a confocal imaging system. FIGS. 13B, 13D, and 13F show photographs of the corresponding surfaces.

FIGS. 14A-14B show the topography of an as-fabricated polycarbonate/ABS printed surface having a textured surface pattern (14A/14B) and after coating with a 2K epoxy-based primer (14C/14D). FIGS. 14A and 14C show the topographical profile as measured using a confocal imaging system. FIGS. 14B and 14D show photographs of the corresponding surfaces of FIGS. 14A and 14C, respectively.

FIG. 15 shows a printed test panel having a wood grain finish.

Reference is now made in detail to embodiments of the present disclosure. While certain embodiments of the present disclosure are described, it will be understood that it is not intended to limit the embodiments of the present disclosure to the disclosed embodiments. To the contrary, reference to embodiments of the present disclosure is intended to cover alternatives, modifications, and equivalents as may be included within the spirit and scope of the embodiments of the present disclosure as defined by the appended claims.

### DETAILED DESCRIPTION

For purposes of the following detailed description, it is to be understood that embodiments provided by the present disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

An “article” such as a three-dimensional printed article refers to, for example, an object, a part, an assembly, a subassembly, a structure, or an apparatus. An article is not limited in size. For example, an article includes handheld devices, automotive vehicle parts, aerospace parts, architectural objects, and engineering structures. An article includes any object that can be fabricated using additive manufacturing such as using three-dimensional printing. An article includes an object comprising a surface or a portion of a surface that has been fabricated using additive manufacturing such as using three-dimensional printing.

“Additive manufacturing” broadly encompasses robotic manufacturing methods. Examples of additive manufacturing include, stereolithography, direct light processing, fused deposition modeling, fused filament fabrication, multi jet modeling, three-dimensional printing, and selective laser sintering. Additive manufacturing processing include, for example, material extrusion, directed energy deposition, material jetting, binder jetting, sheet lamination, vat polymerization, and powder bed fusion. Material used with additive manufacturing methods include thermoplastics, metals, ceramics, and biochemicals. Although three-dimensional printing is specifically referred to in the specification, it will be appreciated that the materials and methods provided by the present disclosure are applicable to any article fabricated using additive manufacturing, including any additive manufacturing method referred to in this paragraph.

“Surface area roughness” is determined using a profilometer or using confocal microscopy. Surface area roughness can be determined, for example, using a wide area 3D optical measurement system such as a Keyence VR-3200 macroscope. Surface area roughness is the extension of Ra (arithmetical mean height of a line) to a surface. Surface area roughness expresses the difference in height of each point compared to the arithmetical mean of the surface.

A height and average height of a feature such as parallel print lines and topographical features can be measured using a profilometer or using confocal microscopy such as using a Keyence VR-3200 macroscope.

“Visually smooth” means that surface features are not visible to a person viewing the surface from a distance of at least 12 inches (30.5 cm).

“Visually apparent” means that surface features are visible to a person viewing the surface from a distance of at least 12 inches (30.5 cm).

“Visually hide print lines” means that the print lines are not visible to a person viewing the surface from a distance of at least 12 inches (30.5 cm).

“Soft-touch coatings” refer to coatings that can impart a range of touch feel, for example, a velvety touch or feel, a silky touch or feel, or a rubbery touch or feel, to a substrate. Soft touch coatings can also exhibit good chemical and mechanical resistance as well as other properties desired in a coating.

“1K” compositions refer to compositions in which coreactive components are combined prior to use such as during shipment and storage, and the reaction initiated immediately prior to and/or during use. The reaction can be initiated, for example, by application of energy such as thermal energy, acoustic energy, mechanical energy, and/or by actinic radiation. A 1K composition can comprise a latent catalyst that is activated immediately before and/or during application. Examples of latent catalysts include moisture activated catalysts, core/shell encapsulants, photoinitiated catalysts, photolabile catalysts, and other latent catalysts. An example of 1K coatings include coatings that are curable by actinic radiation, such as using UV radiation.

“2K” refers to a two-part coating in which the two separate parts are combined immediately before or during use. A two-part coating includes a first part and a second part, where the first part comprises a first reactive component and the second part comprises a second reactive component where the first component is reactive with the second component. When combined prior to application the first and second components coreact to form a coreactive composition. The reaction rate of the coreactive components can be modified by including a catalyst or by application of energy such as thermal energy. A reactive component can comprise a compound having a reactive functional group, and one or more additional components such as, for example, catalysts, filler, rheology control agents, solvent, colorants, photoinitiators, fire retardants, moisture control agents, and combinations of any of the foregoing. Examples of 2K coatings include sprayable urethane/polyol coatings in which the urethane and polyol components are separate and combined during the spraying process to provide a curable coating.

A coreactive composition can comprise a first compound having one or more first functional groups, and a second compound having one or more second functional groups, were the one or more first functional groups are reactive with the one or more second functional groups. In a coreactive composition, a first coreactive compound can comprise one or more first functional groups, and a second coreactive compound can comprise one or more second functional groups where each of the one or more first functional groups is reactive with each of the one or more second functional groups. Each of the one or more first functional groups can be the same or at least some of the first functional groups can be different than other first functional groups. Each of the one or more second functional groups can be the same or at least some of the second functional groups can be different than other second functional groups.

A coreactive composition can comprise at least one third coreactive compound wherein the at least one third coreactive compound can comprise one or more third functional groups such as two or more third functional groups. Each of the one or more third functional groups can be the same or at least some of the third functional groups can be different than other third functional groups. Each of the one or more third functional groups can be reactive with each of the one or more first functional groups, each of the one or more third functional groups can be reactive with each of the one or more second functional groups, each of the one or more third functional groups are reactive with each of the one or more first functional groups and each of the one or more second functional groups, or at least one of the one or more third functional groups is reactive with at least one of the one or more first functional groups and at least one of the one or more third functional groups is reactive with at least one of the one or more second functional groups.

Examples of coreactive functional groups are well known. For example, a first functional group can be a thiol group, and a second functional group can be a thiol group, an alkenyl group, an alkynyl group, an epoxy group, a Michael acceptor group, an isocyanate group, or a combination of any of the foregoing. These curing chemistries can be adapted to provide a balance between a long pot life or useful working time and a fast cure rate. Examples of useful curing chemistries include hydroxyl/isocyanate, amine/isocyanate, epoxy/epoxy, and Michael acceptor/Michael acceptor reactions. Thus, a first functional group can comprise an isocyanate and a second functional group can comprise a hydroxyl group, an amine group, or a combination thereof. A first functional group can comprise an epoxy group and a second functional group can comprise an epoxy group. A first functional group can comprise a Michael acceptor group and a second functional group can comprise a Michael acceptor group. The first functional group can be a Michael acceptor group such as a (meth)acrylate group, a maleic group, or a fumaric group, and the second functional group can be a primary amine group or a secondary amine group. The first functional group can be an isocyanate group and the second functional group can be a primary amine group, a secondary amine group, a hydroxyl group, or a thiol group. The first functional group can be a cyclic carbonate group, an acetoacetate group, or an epoxy group; and the second functional group can be a primary amine group, or a secondary amine group. The first functional group can be a thiol group, and the second functional group can be an alkenyl group, a vinyl ether group, or a (meth)acrylate group. The first functional group can be a Michael acceptor group such as (meth)acrylate group, a cyanoacrylate, a vinylether a vinylpyridine, or an α,β-unsaturated carbonyl group and the second functional group can be a malonate group, an acetylacetonate, a nitroalkane, or other active alkenyl group. The first functional group can be a thiol group, and the second functional group can be an alkenyl group, an epoxy group, an isocyanate group, an alkynyl group, or a Michael acceptor group. The first functional group can be a Michael donor group, and the second functional group can be a Michael acceptor group. Both the first functional group and the second functional group can be thiol groups. Both the first functional group and the second functional group can be alkenyl groups. Both the first functional group and the second functional group can be Michael acceptor groups such as (meth)acrylate groups. A first functional group can be an amine and a second functional group can be selected from an epoxy group, an isocyanate group, an acrylonitrile, a carboxylic acid including esters and anhydrides, an aldehyde, or a ketone. Suitable coreactive functional groups are described, for example, in Noomen, Proceedings of the XIIIth International Conference in Organic Coatings Science and Technology, Athens, 1987, page 251; and in Tillet et al., Progress in Polymer Science, 36 (2011), 191-217.

Coating systems provided by the present disclosure are designed to visually hide low-profile surface features and to establish and/or accentuate the optical properties of high profile surface features.

Surfaces can comprise low-profile features that detract from, interfere with, and/or compromise a desired visual appearance of the surface. Low-profile features can cause the surface to appear dull or hazy. Low-profile features can be distributed randomly over a surface, non-uniformly over a surface, uniformly over a surface. The low-profile features can be irregular, or the low-profile features can be irregular. The low-profile features can be unintentional. For example, the low-profile features can be an artifact of the manufacturing process. For example, certain casting operations can produce articles having a rough surface. Additive manufacturing such as three-dimensional printing can produce surfaces having print lines. The print lines can be parallel features that result from the sequential deposition of material layers. The height of the print lines and the separation between adjacent print lines can depend on a number of factor such as the volume of material deposited with each layer, the speed of printing, the viscosity of the material, the cure rate or the solidification rate of the deposited material, the temperature of the material, the type of material being deposited such as whether the material is a thermoplastic or thermoset, the thickness of the deposited layer, and/or the width of the deposited layer.

Low-profile surface features can be disposed on an otherwise substantially smooth surface. Alternatively, low-profile surface features can be imposed on a surface having an intentional surface topography. For example, a surface of an article can comprise an intentional texture and/or pattern. The intentional texture can provide the surface with a tactile property and or a visual property. An intentional surface topography can be produced by methods such as, for example, molding, thermoforming, embossing, or by imprinting. An intentional surface topography can be produced using additive manufacturing methods such as three-dimensional printing. Intentional surface features can have a higher profile than low-profile surface features. For example, a low-profile surface feature can have a first height above a nominal plane of a surface, and a high-profile feature can have a second height above a nominal plane of a surface, where the second height is greater than the first height. The second height can be, for example, 0.5 times, 1 time, 2 times, 3 times, 5 times, 10 times, 20 times, 50 times, or 100 times greater than the first height. Low-profile surface features can mask or interfere with the visual properties of the high-profile surface features.

Surfaces of articles such as articles fabricated using additive manufacturing including three-dimensional printing can include low-profile surface features such as build lines, also referred to as print lines, that result from the sequential deposition process. Surfaces of such articles can be characterized by parallel striations that can be undesirable. The print lines can result in a visually and/or tactilely rough surface. The print lines can be substantially parallel meaning that adjacent lines are separated by about the same distance throughout a length. Parallel print lines can be linear or non-linear. Additive manufacturing can also be used to fabricate surfaces having an intentional surface topography. The intentional surface topography can take the form, for example, of patterned or textures imparted to the surface. The intentional surface features can be characterized by a profile greater than that of the low-profile surface features such as the build lines.

Coating systems provided by the present disclosure can visually hide or visually smooth the low-profile surface features and can be used to establish the optical properties of the high-profile features. For example, one or more coating layers can be applied to a surface having low-profile features such that the surface features are not visually apparent. In addition, the coatings can be used to modify the visual appearance of the high-profile topographical features. Examples of modifications include accentuating the intentional surface features, modifying the reflection and/or the reflection angle of the intentional surface features, and/or modifying the contrast of the intentional surface features. The optical properties can include the properties in the ultraviolet, visible, and/or the infrared regions of the electromagnetic spectrum. The optical properties can include the optical properties in the visible region of the electromagnetic spectrum such as would be apparent to a person viewing a surface having the intentional surface features.

Multilayer coatings provided by the present disclosure can include a primer coating, a sealer coating layer, a basecoat layer, a mid-coat layer, a topcoat layer, an exterior coating layer, or a combination of any of the foregoing. The coating chemistry can include and suitable coating chemistry such as urethane/polyol coating chemistries and epoxy coating chemistries. The coatings can be applied to a surface using any suitable method including by spraying. Suitable multilayer coating chemistries include refinish coatings such as automotive refinish coatings. The chemistry of individual coating layers can differ from that of other coating layers. Certain coating layers can be aqueous-based.

A primer coating layer can be selected to provide adhesion to the underlying substrate. A primer coating layer can be selected to enhance adhesion to an underlying substrate. For example, a primer coating layer can be a urethane-based primer coating layer or an epoxy-based primer coating layer.

A sealer coating layer can prevent or minimize the diffusion of solvents and water from the environment to an underlying primer coating layer. A sealer coating layer can also prevent or minimize the diffusion of constituents of the substrate from migrating to the upper layers of the multilayer coating. For example, a sealer coating layer can be a urethane-based sealer coating layer or an epoxy-based sealer coating layer.

Basecoats and mid-coats can be used to modify the appearance and the color of the multilayer coatings. The basecoats and the mid-coats can be clear, can contain pigments, and/or can contain light scattering additives.

A topcoat can be the uppermost coating layer. A topcoat can be, for example, clear, can be a gloss coating, or can exhibit a matte finish. A topcoat can be, for example, abrasion resistant.

An exterior coating layer can impart one or more desired features to the multilayer structure. For example, the exterior coating layer can be scratch resistant, abrasion resistant, stain resistant, fingerprint resistant, resistant to cleaning fluids, impart aesthetic qualities, and/or impart tactile properties. As an example of the latter, the exterior coating layer can be a haptic coating such as a soft-touch coating.

The functions and properties of the layers can be combined in a single layer and are not necessarily mutually exclusive. In general, a multilayer coating can have a first coating layer, which can be applied to an underlying substrate to smooth or visually hide the low-profile topographical features and to provide adhesion between the substrate and one or more overlying layers of the multilayer coating system.

A coating system provided by the present disclosure can comprise a electrocoat coating system, which can be applied to a metal surface, an alloy surface, an electrically conductive thermoplastic surface, or an electrically conductive thermoset surface. A substrate can be contacted with a coating composition comprising a film-forming resin by an electrocoating step wherein an electrodeposition composition is deposited onto the electrically conductive substrate by electrodeposition. In the process of electrodeposition, an electrically conductive substrate being treated, serves as an electrode, and an electrically conductive counter electrode can be placed in contact with an ionic, electrodeposition composition. Upon passage of an electric current between the electrode and counter electrode while they are in contact with the electrodeposition composition, an adherent film of the electrodeposition composition can be deposited in a substantially continuous manner on the metal substrate. Electrodeposition can be carried out at a constant voltage in the range of from 1 volt to several thousand volts, such as between 50 and 500 volts. Current density can be between 1.0 A/ft² and 15 A/ft² (10.8 A/m² to 161.5 A/m²) and can decrease during the electrodeposition process, indicating formation of a continuous self-insulating film. An electrodeposition composition can comprise a resinous phase dispersed in an aqueous medium wherein the resinous phase comprises: (a) an active hydrogen group-containing ionic electrodeposition resin, and (b) a curing agent having functional groups reactive with the active hydrogen groups of (a). An electrodepositable compositions can comprise, as a main film-forming polymer, an active hydrogen-containing ionic, often cationic, electrodeposition resin. Examples of electrocoatings are disclosed, for example, in U.S. Application Publication No. 2016/00204055 and in U.S. Application Publication No. 2019/0040530, each of which is incorporated by reference in its entirety.

Coating systems can be applied to a surface of any suitable article in which it is desirable to visually hide low-profile surface features and establish the optical properties of high profile surface features such as patterns and textures.

An article can be, for example, a thermoplastic, a thermoset, a metal, an alloy, a ceramic, a composite, or a combination thereof. An article can be fabricated using additive manufacturing such as by three-dimensional printing. An article can be an article comprising a surface, where the surface is fabricated using additive manufacturing, such as by three-dimensional printing. For example, an article can comprise a substrate comprising a metal and a surface comprising a thermoplastic deposited using three-dimensional printing.

Examples of suitable thermoplastics include polycarbonates, acrylonitrile butadiene styrene (ABS), polyurethanes, polyureas, polyamides, polypropylene, polyethylene, polystyrene, polyvinylcarbonates, polybutylene terephthalates, polyetheretherketones, polyetherketones, polyethylene terephthalates, polyimides, polyetherimides, polyphenylene sulfides, polyphenylene oxides, polysulfones, polytetrafluoroethelenes, thermoplastic elastomers, and combinations of any of the foregoing.

Examples of suitable thermosets include polyesters, polyurethanes, polyureas, phenol-formaldehydes, urea-formaldehydes, melamines, diallyl-phthalates, epoxies, benzoxazine, polyimides, bismaleimides, cyanate esters, silicones, vinyl esters, and combinations of any of the foregoing.

Examples of suitable metals include aluminum, chromium, copper, nickel, iron, magnesium, titanium, cobalt, zinc, and alloys of any of the foregoing.

Plastics are used in a wide variety of molding applications for the preparation of molded articles for use in the automotive, industrial, aerospace, and appliance markets, among others. Vehicles, for example, include many interior and exterior articles and attachments that are constructed from plastics, such as mirror casings, fenders, bumper covers, spoilers, dashboards, and interior trim. Aerospace vehicles such as commercial aircraft also include exterior and interior articles fabricated from polymeric materials. The preparation of such articles generally includes the steps of molding an article and applying to the molded article one or more film-forming coating layers to protect and/or color the article.

Increasingly, such articles are being fabricated using additive manufacturing technologies such as three-dimensional printing. Metal and composite articles are also being fabricated using various additive manufacturing technologies.

One or more layers of a coating system can be deposited from a coating composition that includes a thermosetting polymeric composition. A thermosetting composition refers to polymeric compositions that “set” irreversibly upon curing or crosslinking, wherein the polymer chains of the polymeric components are joined together by covalent bonds. This property is usually associated with a cross-linking reaction of the composition constituents often induced, for example, by heat or radiation. Curing or crosslinking reactions also may be carried out under ambient conditions. Once cured or crosslinked, a thermosetting resin will not melt upon the application of heat and is insoluble in solvents. In other embodiments, one or more layers of the protective and decorative coating system may be deposited from a coating composition that includes a thermoplastic polymeric composition. A thermoplastic refers to polymeric compositions that comprise polymeric components that are not joined by covalent bonds and thereby can undergo liquid flow upon heating and are soluble in solvents.

One or more layers of the coating system can be deposited from a liquid composition that includes a polymeric composition and a diluent, that is, waterborne or solvent-borne systems. Suitable diluents include organic solvents, water, and water/organic solvent mixtures. Organic solvents in which such polymeric compositions may be dispersed include, for example, alcohols, ketones, aromatic hydrocarbons, glycol ethers, esters, and mixtures thereof. The diluent can be present, for example, in an amount from 5 wt % to 80 wt %, such as from 30 wt % to 50 wt %, where wt % is based on the total weight of the composition.

One or more layers of a coating system can be deposited from a coating composition that includes a polymeric composition comprising, for example, hydroxyl or carboxylic acid-containing acrylic copolymers, hydroxyl or carboxylic acid-containing polyester polymers and oligomers, isocyanate or hydroxyl-containing polyurethane polymers, and/or amine or isocyanate-containing polyureas.

Acrylic polymers include copolymers of acrylic acid or methacrylic acid or hydroxyalkyl esters of acrylic or methacrylic acid such as hydroxyethyl methacrylate or hydroxypropyl acrylate with one or more other polymerizable ethylenically unsaturated monomers such as alkyl esters of acrylic acid including methyl methacrylate and 2-ethyl hexyl acrylate, and vinyl aromatic compounds such as styrene, alpha-methyl styrene and vinyl toluene. The ratio of reactants and reaction conditions are selected to result in an acrylic polymer with pendant hydroxyl or carboxylic acid functionality.

One or more layers of the coating system can be deposited from a coating composition that includes a polymeric composition that includes a polyester polymer or oligomer. Such polymers may be prepared in a known manner by condensation of polyhydric alcohols and polycarboxylic acids. Suitable polyhydric alcohols include, for example, ethylene glycol, neopentyl glycol, trimethylol propane and pentaerythritol.

Suitable polycarboxylic acids include, for example, adipic acid, 1,4-cyclohexyl dicarboxylic acid and hexahydrophthalic acid. In addition to the polycarboxylic acids mentioned above, functional equivalents of the acids such as anhydrides where they exist or lower alkyl esters of the acids such as the methyl esters may be used. Also, small amounts of monocarboxylic acids such as stearic acid may be used.

Hydroxyl-containing polyester oligomers can be prepared by reacting an anhydride of a dicarboxylic acid such as hexahydrophthalic anhydride with a diol such as neopentyl glycol in a 1:2 molar ratio.

Where it is desired to enhance air-drying, suitable drying oil fatty acids may be used and include, for example, those derived from linseed oil, soya bean oil, tall oil, dehydrated castor oil or tung oil.

Polyesters may, for example, contain free terminal hydroxyl and/or carboxyl groups that are available for further crosslinking reactions.

Polyurethane polymers containing terminal isocyanate or hydroxyl groups may also be present in the coating compositions from which one or more layers of the coating systems are deposited. Polyurethane polyols or NCO-terminated polyurethanes that can be used include, for example, those prepared by reacting polyols including polymeric polyols with polyisocyanates. The polyurea-containing terminal isocyanate or primary or secondary amine groups which can be used include, for example, those prepared by reacting polyamines including polymeric polyamines with polyisocyanates. The hydroxyl/isocyanate or amine/isocyanate equivalent ratio can be adjusted, and the reaction conditions selected to obtain the desired terminal group. Examples of suitable polyisocyanates include those described in U.S. Pat. No. 4,046,729 at column 5, line 26 to column 6, line. Examples of suitable polyols include those described in U.S. Pat. No. 4,046,729 at column 7, line 52 to column 10, line 35. Examples of suitable polyamines include those described in U.S. Pat. No. 4,046,729 at column 6, line 61 to column 7, line 32 and in U.S. Pat. No. 3,799,854 at column 3, lines 13 to 50.

One or more layers of a coating system can be deposited from a curable coating composition that includes a curing agent, such as aminoplast resins and phenoplast resins and mixtures thereof, as curing agents for OH and COOH, and amide and carbamate functional group containing materials. Examples of aminoplast and phenoplast resins suitable as curing agents in such curable compositions include those described in U.S. Pat. No. 3,919,351 at col. 5, line 22 to col. 6, line 25.

Polyisocyanates and blocked polyisocyanates useful as curing agents for hydroxyl and primary and/or secondary amino group containing materials are well known in the art. Examples of suitable polyisocyanates and blocked isocyanates include those described in U.S. Pat. No. 4,546,045 at col. 5, lines 16 to 38; and in U.S. Pat. No. 5,468,802 at col. 3, lines 48 to 60, each of which is incorporated by reference in its entirety.

Anhydrides as curing agents for OH and primary and/or secondary amino group containing materials are well known in the art. Examples of suitable anhydrides include those described in U.S. Pat. No. 4,798,746 at col. 10, lines 16 to 50 and in U.S. Pat. No. 4,732,790 at col. 3, lines 41 to 57, each of which is incorporated by reference in its entirety.

Polyepoxides as curing agents for COOH functional group containing materials are well known in the art. Examples of suitable polyepoxides include those described in U.S. Pat. No. 4,681,811 at col. 5, lines 33 to 58, which is incorporated by reference in its entirety.

Polyacids as curing agents for epoxy functional group containing materials are well known in the art. Examples of suitable polyacids include those described in U.S. Pat. No. 4,681,811 at col. 6, line 45 to col. 9, line 54, which is incorporated by reference in its entirety.

Polyols, that is, a material having an average of two or more hydroxyl groups per molecule, can be used as curing agents for NCO functional group containing materials and anhydrides and esters and are well known in the art. Examples of suitable polyols include those described in U.S. Pat. No. 4,046,729 at col. 7, line 52 to col. 8, line 9; col. 8, line 29 to col. 9, line 66 and in U.S. Pat. No. 3,919,315 at col. 2, line 64 to col. 3, line 33, each of which is incorporated by reference in its entirety.

Polyamines can also be used as curing agents for NCO functional group containing materials and for carbonates and unhindered esters and are well known in the art. Examples of suitable polyamines include those described in U.S. Pat. No. 4,046,729 at col. 6, line 61 to col. 7, line 26, each of which is incorporated by reference in its entirety.

One or more layers of the coating system can be deposited from a coating composition that includes, in addition to the components described, a variety of other adjuvant materials. If desired, other polymeric compositions can be utilized in conjunction with the polymeric compositions described above so long as the resultant coating composition is not detrimentally affected in terms of application, physical performance and appearance properties.

One or more layers of the coating system can be deposited from a coating composition that includes a catalyst to accelerate the cure reaction. Examples of suitable catalysts include organotin compounds such as dibutyl tin dilaurate, dibutyl tin oxide and dibutyl tin diacetate. Catalysts suitable for promoting the cure reaction between an aminoplast curing agent and the reactive hydroxyl and/or carbamate functional groups of the thermosettable dispersion include acidic materials, for example, acid phosphates such as phenyl acid phosphate, and substituted or unsubstituted sulfonic acids such as dodecylbenzene sulfonic acid or paratoluene sulfonic acid.

One or more layers of a coating system can be deposited from a coating composition that includes one or more other additive ingredients, including those which are well known in the art of formulating surface coatings, such as dyes, pigments, surfactants, flow control agents, thixotropic agents, fillers, anti-gassing agents, organic co-solvents, catalysts, and other customary auxiliaries. Examples of these materials and suitable amounts are described in U.S. Pat. Nos. 4,220,679, 4,403,003, 4,147,769 and 5,071,904, each of which is incorporated by reference in its entirety.

A coating system can be applied to a surface of an article, where the coating system comprises a coating layer deposited from a coating composition that comprises an adhesion promoting agent. The adhesion promoting agent or combination of adhesion promoting agents can be selected based on the surface to which the coating system is being applied. Such a composition includes a resin that is compatible with the adhesion promoting agent and may be applied by any suitable application technique. In these embodiments, the composition may comprise a halogenated polyolefin that is modified by grafting a compatibilizing material onto the polyolefin as described above. For example, if a primer layer is present in the protective and decorative coating system, then the composition from which such a layer is deposited may include such an adhesion promoting agent. Alternatively, if such a layer is not present, the adhesion promoting agent may be present in the basecoat of a multi-layered coating system or it may be present in the composition from which the single coat of a single layer coating system is deposited. An adhesion promoting agent may be present in more than one layer of the protective and decorative coating system.

Therefore, certain methods of the present invention comprise the steps of (a) applying a composition comprising an adhesion promoting agent to at least a portion of a surface of an article by a first application technique; and (b) applying a protective and decorative coating system over at least a portion of the composition applied in step (a). In these methods of the present invention, the protective and decorative coating system comprises a coating layer deposited from a coating composition that comprises an (i) adhesion promoting agent comprising a halogenated polyolefin that, in certain embodiments, may be modified by grafting a compatibilizing material onto the polyolefin, and (ii) a resin that is compatible with the adhesion promoting agent. Such resins may include any of the thermosetting or thermoplastic polymeric compositions described herein. Moreover, such a coating layer may be deposited by an application technique that is the same as or different from the first application technique.

A coating layer of the coating system can comprise, for example, from 1.0 wt % to 5.0 wt % of an adhesion promoting agent, where wt % is based on the total weight of the composition. The amount of the adhesion promoting agent present in such coating compositions may range between any combination of these values, inclusive of the recited values.

The coating compositions from which one or more layers of the coating system are deposited may be applied by any conventional coating technique, such as brushing, spraying, dipping, or flowing, among others. In certain embodiments, such compositions are applied by spraying. Moreover, the means for applying such compositions can comprise a spray gun or an aerosol can.

Coating systems provided by the present disclosure can comprise a primer coating overlying a surface of an article.

A primer coating can comprise any suitable primer composition such as a urethane-based primer composition or an epoxy-based primer composition.

Examples of suitable urethane-based primer compositions include ECP 15, a 2K urethane-based primer composition available form PPG Industries, Inc.

Examples of suitable epoxy-based primer compositions include DP 50LF and VP 2050, both of which are 2K epoxy-based primer compositions available from PPG Industries, Inc.

Epoxy-based primer coatings can be selected to provide a desired adhesion to a surface of an article.

A primer coating may be applied to any suitable thickness.

For example, a primer coating can have a thickness from 5 μm to 80 μm, from 10 μm to 60 μm, from 15 μm to 50 μm, from 20 μm to 30 μm, or from 40 μm to 70 μm.

Surfaces of articles fabricated using three-dimensional printing can have low-profile features in the form of build lines or print lines. Build and print lines are characterized by roughly parallel features that can have a height, for example, from 10 μm to 200 μm, from 50 μm to 200 μm such as from 55 μm to 150 μm and can be separated, for example, by from 10 μm to 200 μm, by from 10 μm to 100 μm, or from 15 μm to 50 μm. The parallel build lines produce a surface having a grooved or striated appearance. It can be desirable to visually hide the build lines to produce a substantially visually smooth surface. This can be accomplished by applying a primer coating layer and one or more additional coating layer to a sufficient thickness to effectively hide the build lines by filling in the depressions or features between the ridges or high points.

Following application of coating layer to a surface, the coating can be abraded or sanded. An applied coating layer can substantially conform to the low-profile, and if present, the high-profile features of the surface. A portion of a coating layer overlying the low-profile and/or high-profile surface features can be removed by abrading the coating layer. The coating layer can be abraded such that the thickness of the coating layer overlying the surface features is reduced without substantially reducing the thickness of the coating layer in the depressions between the surface features. In this way, a coating layer fills the depressions between the surface features thereby reducing the surface area roughness of the surface. A coating layer is not abraded to the extent that the underlying low-profile or high-profile surface feature is abraded. In this process, the thickness of individual surface layers is less than the height of a low-profile surface feature such as less than 10%, less than 20% less than 30%, less than 40%, less than 50%, or less than 60% the height of a low-profile surface feature.

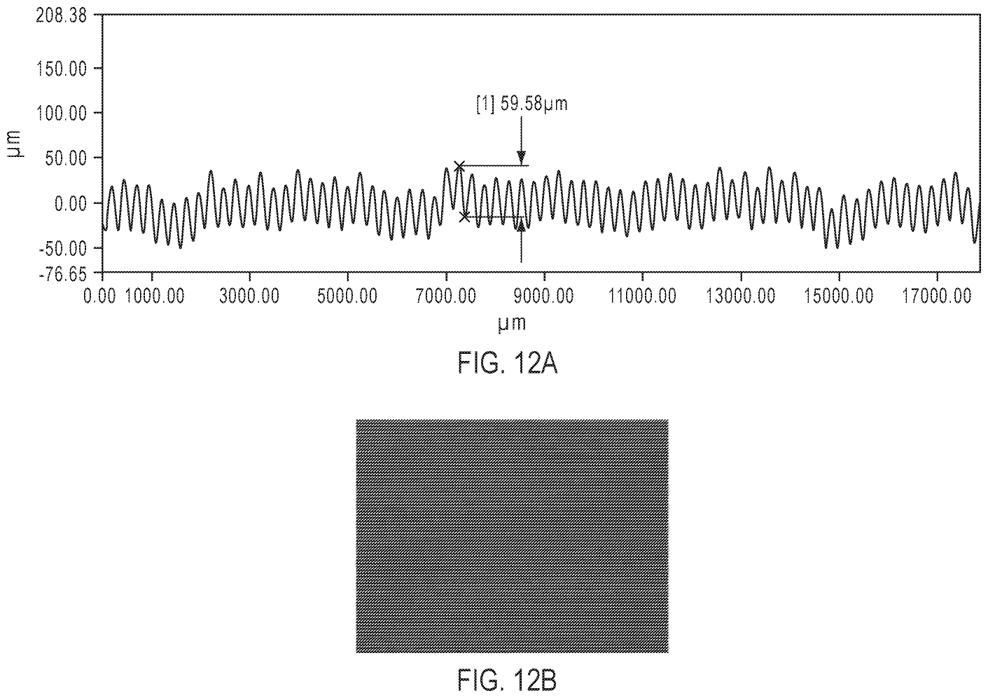

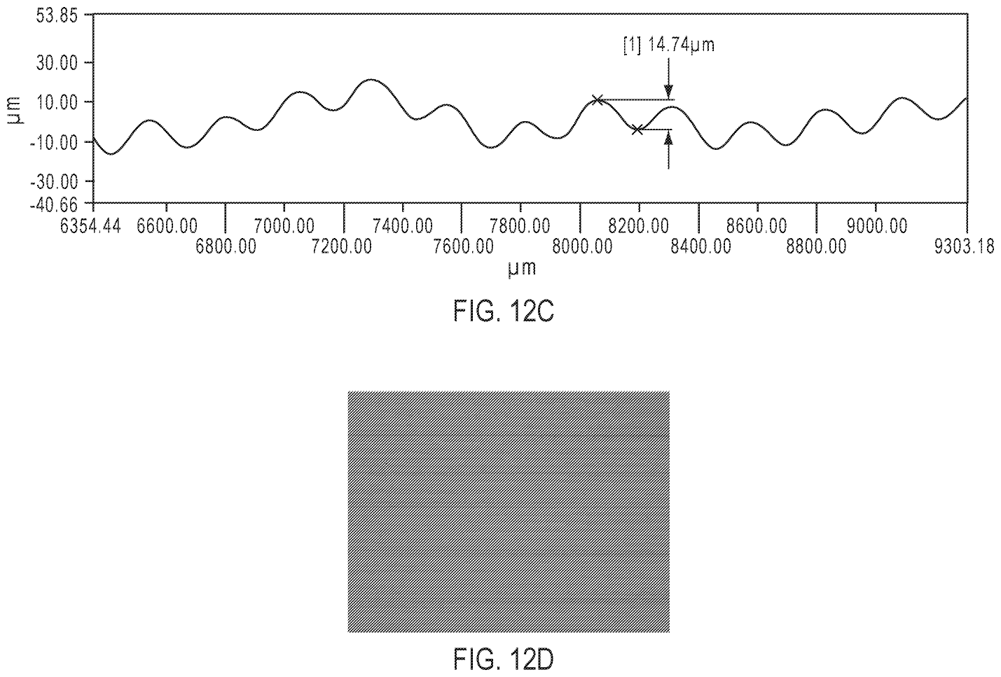

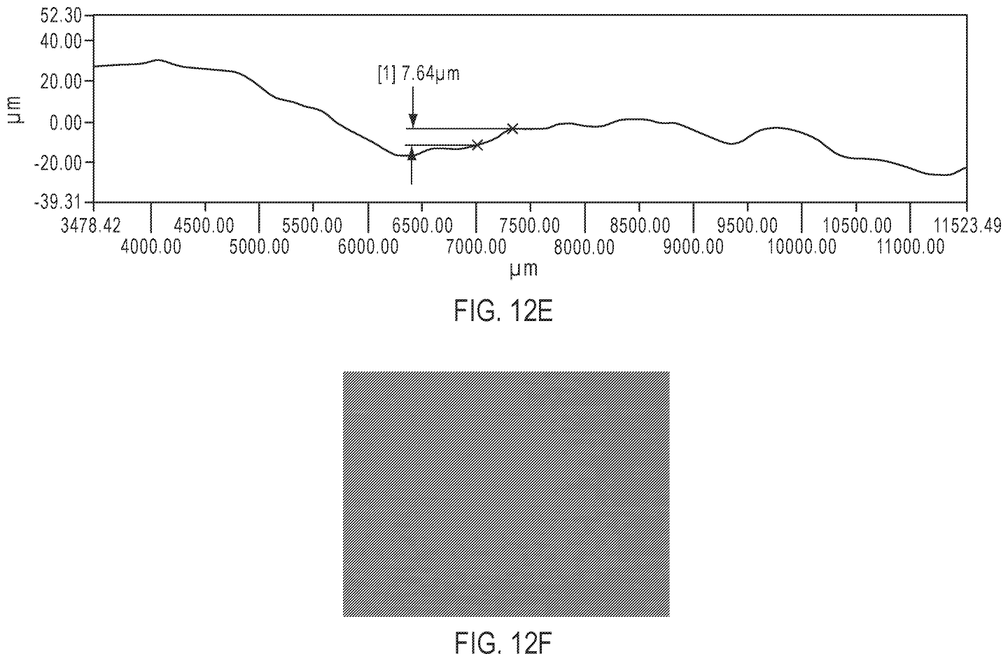

FIGS. 12A-12D show the surface topography of a polycarbonate/ABS article fabricated using three-dimensional printing. The surface is characterized by parallel features separated by about 25 μm and having a height of about 60 μm as measured using confocal microscopy (FIG. 12A). As shown in FIG. 12B, the surface was visually grooved.

As shown in FIG. 12C after a 25 μm thick coating of a 2K urethane-based primer (ECP15) was applied to the surface shown in FIGS. 12A and 12B, the average height of the build lines was reduced to about 15 μm. As shown in FIG. 12D, visually, the surface shows striations rather than the more deeply grooved surface without the primer coating.

As shown in FIG. 12E, following application of a 50 μm- to 65 μm-thick 2K epoxy-based primer coating (VP2050) to the coated surface shown in FIGS. 12A and 12B, the surface topography was reduced to about 8 μm, and is no longer visually characterized by regularly spaced striations. As shown in FIG. 12F, the surface appears visually smooth.

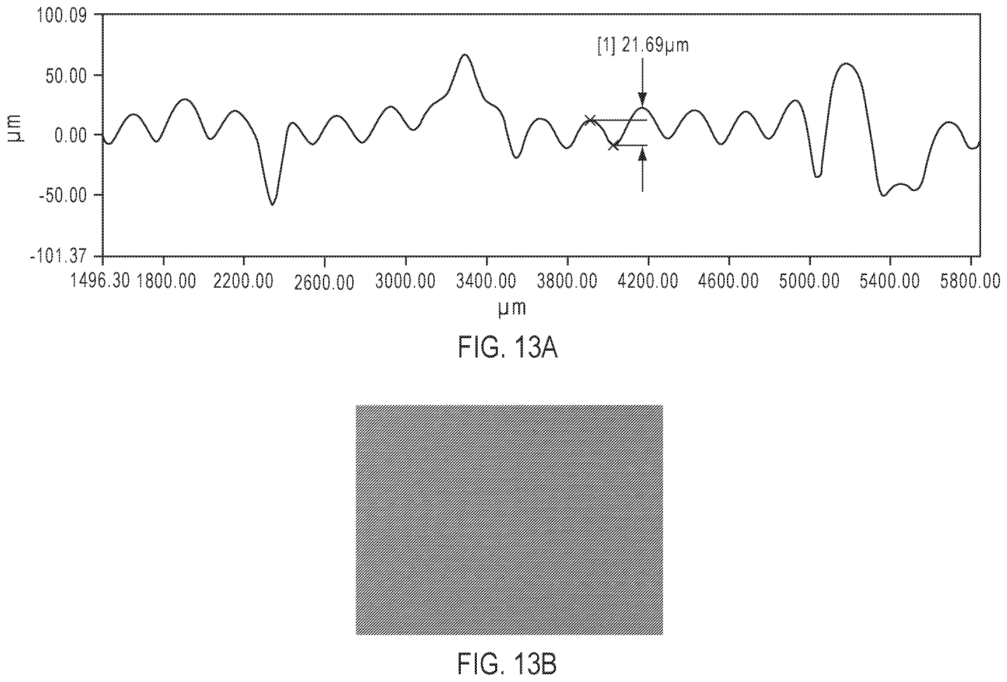

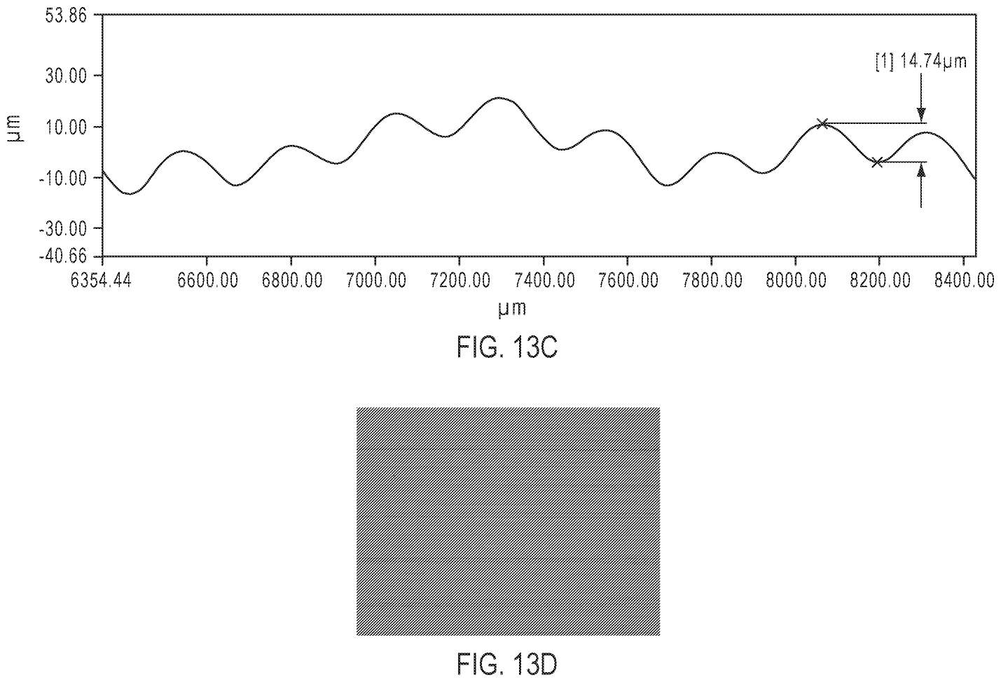

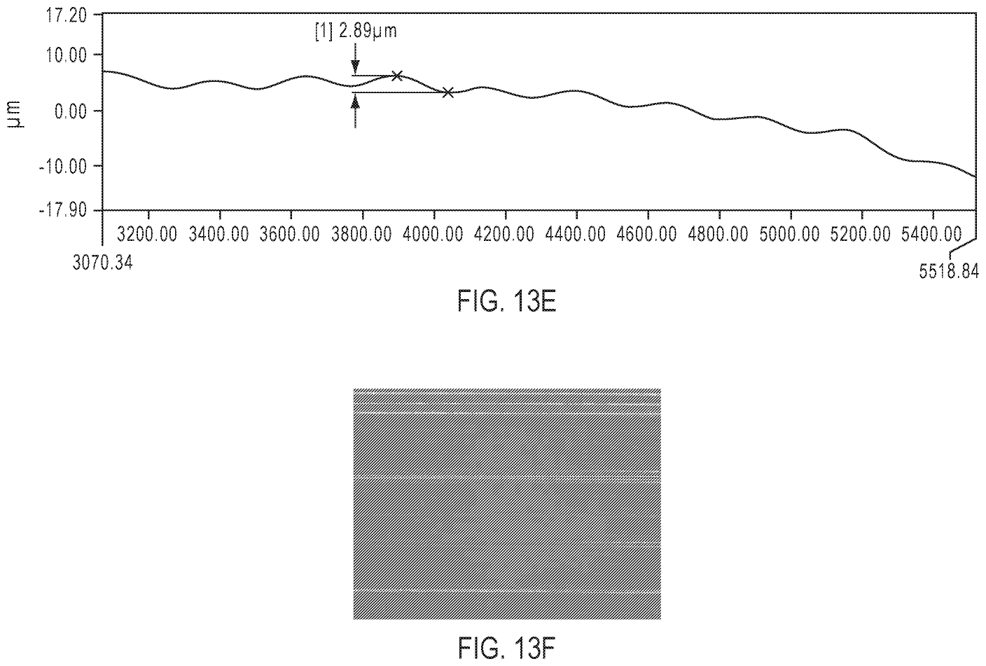

FIGS. 13A-13F show similar results for an Ultem® 9085 (polyetherimide) article fabricated using three-dimensional printing, before and after coating the surface with a 2K urethane-based primer coating and a 2K epoxy-based primer coating consistent with FIGS. 12A-12F. The uncoated Ultem® 9085 surface was characterized by features separated by about 100 μm and having a height of 22 μm. The surface area roughness (Sa) was reduced from 14.4 μm (FIGS. 13A-13B), to 7.5 μm by applying a 25 μm thick coating with the 2K urethane epoxy primer (ECP15) (FIGS. 13C-13D), and to 1.5 μm after applying the 50 μm- to 65 μm thick 2K epoxy primer (VP2050) (FIGS. 13E-13F).

To visually hide the print lines such that a surface appears visually smooth, a coating system can have a total thickness, for example, that is within +1-50% of the average height of the print lines, such as within +/−40%, within +/−30%, within +/−20%, within +/−15%, within +1-10%, or within +/−5%. A coating system for hiding print lines can comprise one or more layers, where each of the layers can independently be the same or different. Each of the layers can independently have a thickness, for example, from 1 μm to 50 μm, from 2 μm to 40 μm, from 5 μm to 35 μm, or from 10 μm to 30 μm. A coating system for hiding the print lines can have, for example, from 1 to 10 layers, from 2 to 8 layers, or from 3 to 6 layers.

After application of a coating system, the plurality of parallel features can have an average feature height less than 10 μm, less than 8 μm, less than 6 μm, or less than 4 μm. After application of a coating system, the surface can be characterized by an average surface area roughness less than 10 μm, less than 8 μm, less than 6 μm, or less than 4 μm. Before application of a coating system, the surface can be characterized by an average surface area roughness less than 10 μm, less than 8 μm, less than 6 μm, or less than 4 μm. To visually hide the low-profile features such as the print lines the coating system need not be sufficiently thick to extend above the low-profile features and provide a planar surface. A coating system can preferentially fill the space between the low-profile features. The visual effects of the low-profile features such as print lines can become visually hidden with the surface area roughness is less than 10 μm.

Build lines and print lines can be artifacts of the sequential processes used in additive manufacturing. Build lines and print lines are generally not desirable and various methods are used to remove or high the features. Typical methods involve abrading or sanding the surface to remove the print lines or completely covering the print lines with a coating. For as-fabricated surfaces that contain both print lines and intentional high-profile topographical features, abrading the print lines may be difficult to accomplish without adversely affecting the high-profile surface topography. For example, low-profile features such as print lines between the high-profile surface features can be difficult to remove by abrasion.

It can be desirable to intentionally incorporate topographical features into a surface of a three-dimensional printed article. Such features can take to form of regular or irregular patterns to create intentional visual effects. These features can have a height that is, for example, greater than about 4 times, greater than 6 times, greater than 8 times, or greater than 10 times that of the build lines. The patterns can have characteristic in-plane dimensions (in the surface plane) that are also much larger than those of the build lines. For example, characteristic in-plane dimensions can be greater than 500 μm, greater than 1,000 μm or greater than 2,000 μm. Despite the feature dimensions being much larger than that of the build lines, the build lines can dominate the visual appearance of the surface of a three-dimensional printed article. The topographical features can comprise an irregular pattern such as a leather-textured surface. The topographical features can comprise a regular pattern. For example, the plurality of regular topographical features can be separated by a distance that is greater than the separation between the parallel print lines. In some cases, it can also be desirable to accentuate print lines. For example, print lines can comprise raised features that simulate a wood-grain appearance. Depending on the coating, the wood-grain features can visually appear to be flush against the surface of the article or can visually appear to be raised above the surface of the article. Therefore, it can be appreciated that a coating system can be selected to visually hide the print lines or to visually accentuate the print lines as desired. Print lines that are intended to be accentuated are included within the scope of intentional features.

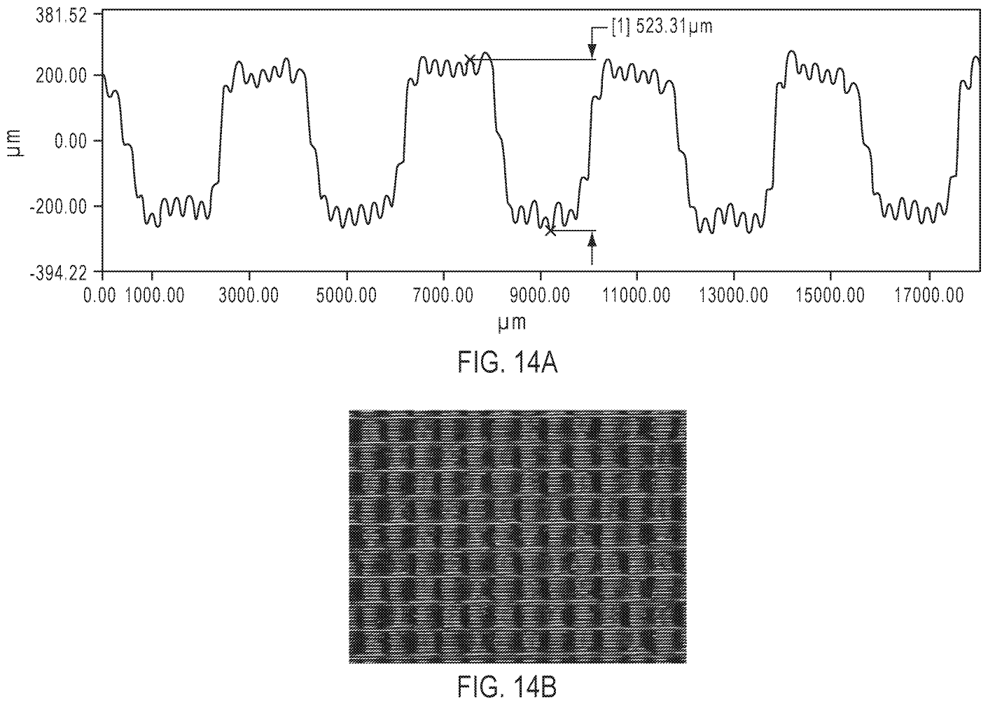

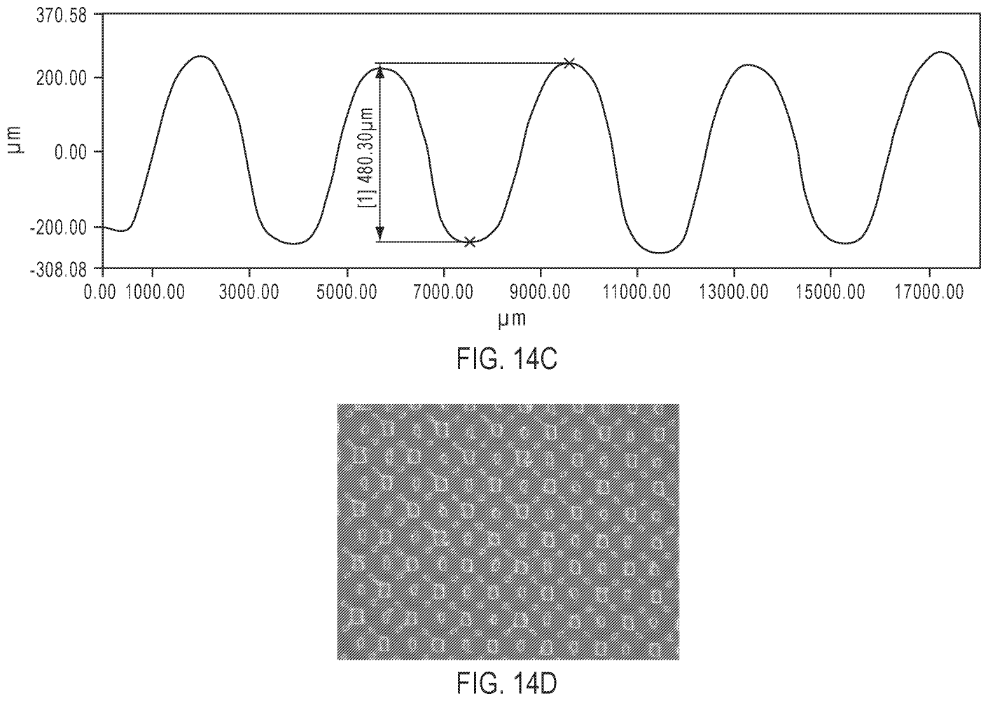

This is shown in FIGS. 14A-14D. The surface was intentionally fabricated to include a pattern consisting of small and large box-like features. FIG. 14A shows the surface topography of a polycarbonate/ABS article fabricated using three-dimensional printing. The intentional features have a height of about 523 μm separated by about 3,000 μm. Visually, as shown in FIG. 14B, the intentional box pattern is visually masked by the build lines. As shown in FIGS. 14C-14D, following application of a 50 μm to 65 μm-thick layer of a 2K epoxy-based primer (VP 2050), the build lines are completely visually masked and the intentional features, although being smoothed, are maintained. The height of the intentional features is reduced from 523 μm to 480 μm as a result of the primer coating. In effect, the coating layer fills in between the intentional features. As shown in FIG. 14D, by hiding the build lines, the intentional surface features become resolved and are readily apparent as a regular pattern of small and large box-like structures. The coated surface was not abraded. In between the intentional topographic features, the coating layer was sufficiently thick to cover the low-profile print lines.

In addition to a primer that is used to enhance addition of a multilayer coating to a surface, various additional coating layers can be applied over the primer.

For example, these additional layers can include a sealer, a basecoat, and a mid-coat basecoat, and a topcoat.

A sealer can be used to improve the surface adhesion of the coating system by providing a barrier to solvent migration to the underlying primer/article interface. Examples of suitable sealers include ECS25.

A basecoat can include a colorant such as a pigment or color-effect material.

A mid-basecoat layer can include special effect pigments and can be applied overlying an in addition to the basecoat. An example of a suitable mid-basecoat is the Andaro® special effects coating available from PPG Industries, Inc. Andaro® is an example of a coating composition comprising a colorant can be in the form of a dispersion such as a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm.

Examples of nanoparticle dispersions and methods for making them are disclosed, for example, in U.S. Pat. No. 6,875,800 B2 and in U.S. Application Publication No20050287354, each of which is incorporated by reference in its entirety. Nanoparticle dispersions can also be produced by crystallization, precipitation, gas phase condensation, and chemical attrition, i.e., partial dissolution. Dispersions of non-hiding, color-imparting organic pigment nanoparticles offer particularly useful aesthetic properties. Low levels of blue nanopigments can offset any yellowing that may occur during curing of film-forming compositions. Blue or black nanopigments enhance the appearance of the anti-glare coating, particularly over black underlayers on a substrate. Moreover, colored nanopigments may be chosen to enhance or complement the underlying color of an article.

A topcoat can be applied as the outer coating layer of the multi-layer coating system. A topcoat can serve a number of purposes including abrasion resistance, scratch resistance, stain resistance, fingerprint resistance, intumescence, or to facilitate cleaning. A topcoat can also impart desired optical properties such as being visually clear or having a matte finish to reduce reflection. Examples of suitable clear coats include, DC4000, available from PPG Industries, Inc. Examples of suitable matte topcoats include D8115. Examples of suitable coating chemistries include isocyanate-based and epoxy-based coatings.

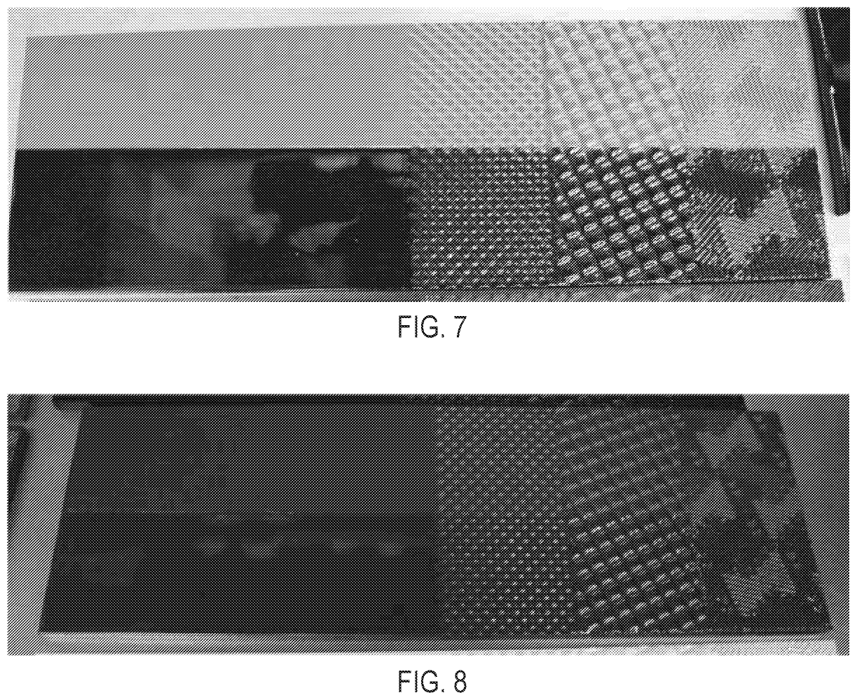

The selection and thickness of the coating layers can dramatically impact the visual appearance of an intentionally textured surface. These effects are illustrated in FIGS. 7 and 8. The effects include amplifying the intentional topography and modifying the directional reflectivity. The effects can be enhanced when a mid-basecoat containing a special effect pigment such as the Vibrance Collection® including the Crystal Pearl™ and Crystallance® product lines and the Andaro® pigments available from PPG Industries, Inc.

An exterior coating can comprise a coating that provides a tactile property or haptic property. For example, a coating can impart a soft-touch feel.

For example, suitable soft-touch coatings are disclosed in International Application Publication No. WO 2016/201103, and in U.S. Application Publication No. 2014/0220354, and U.S. Application Publication No. 2015/0307738, each of which is incorporated by reference in its entirety.

Coating systems provided by the present disclosure can contain a colorant. A colorant can be present in one or more of the coating layers. For example, a colorant can be present in the primer coating, the sealer coating layer, the basecoat layer, the mid-coat layer or a combination of any of the foregoing. Coating layers within the coating system can comprise one or more colorants. A coating layer can comprise a colorant that is the same or different than a colorant in another coating layer.

A colorant refers to a substance that imparts color and/or other visual effect to the coating system. A colorant can be added to the coating in any suitable form, such as discrete particles, dispersions, solutions and/or flakes. A single colorant or a mixture of two or more colorants can be used in a coating layer.

Examples of colorants include pigments, dyes and tints, such as those used in the paint industry and/or listed in the Dry Color Manufacturers Association (DCMA), as well as special effect compositions and materials. A colorant can include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle.

Examples of suitable pigments and/or pigment compositions include carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (DPPBO red), carbon black, and combinations of any of the foregoing.

Examples of suitable dyes include those that are solvent and/or aqueous based such as add dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, quinizarin blue (D&C violet No. 2), and triphenyl methane.

Examples of suitable tints include pigments dispersed in water-based or water miscible carriers such as Aqua-Chem® 896 commercially available from Degussa, Inc., Charisma Colorants® and Maxitoner® Industrial Colorants commercially available from Accurate Dispersions division of Eastman Chemical, Inc.

A colorant can be in the form of a dispersion including, for example, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Examples of nanoparticle dispersions and methods for making them are identified in U.S. Pat. No. 6,875,800 B2, U.S. Application Publication No. 2005/0287354, U.S. Application Publication No. 2009/0326098, and U.S. Application Publication No. 2006/0251896, each of which is incorporated by reference in its entirety. Nanoparticle dispersions can also be produced by crystallization, precipitation, gas phase condensation, and chemical attrition (i.e., partial dissolution). To minimize re-agglomeration of nanoparticles within the coating, a dispersion of resin-coated nanoparticles can be used. A “dispersion of resin-coated nanoparticles” refers to a continuous phase in which is dispersed discreet “composite microparticles” that comprise a nanoparticle and a resin coating on the nanoparticle.

Dispersions of non-hiding, color-imparting organic pigment nanoparticles offer particularly useful aesthetic properties in the electronics industry. Such pigment dispersions are available from PPG Industries, Inc. under the trademark Andaro®. Low levels of blue nanopigments can offset any yellowing that may occur during curing of film-forming compositions. Blue or black nanopigments enhance the appearance of the anti-glare coating, particularly over black underlayers on an article. Moreover, colored nanopigments may be chosen to enhance or complement the underlying color of the article, such as an additively manufactured article. Nanoparticle dispersion are particularly suitable for use in curable film-forming sol-gel compositions of the present invention that comprise (i) a tetraalkoxysilane; (ii) an epoxy functional trialkoxysilane; (iii) a metal-containing catalyst; (iv) a solvent component; and (v) non-oxide particles.

Other suitable special effect colorants include those with in the Vibrance Collection® available from PPG Industries, Inc., including, for example, the Crystal Pearl, Crystallance®, Ditzler®, Flamboyance®, Harlequin®, Liquidmetal®, Starfire®, and Radiance®.

Examples of special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. Special effect compositions can produce a color shift, such that the color of the coating changes when the coating is viewed at different angles. Examples of color effect compositions are disclosed, for example, in U.S. Pat. No. 6,894,086. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, a colorant can be present in the coating layer in any amount sufficient to impart a desired property, visual and/or color effect. For example, a colorant may be present in an amount from 1 wt % to 65 wt %, such as from 3 wt % to 40 wt % or from 5 wt % to 35 wt %, where wt % is based on the total weight of the coating composition used to form the coating layer.

Other examples of materials that can be used with the coating systems provided by the present disclosure include plasticizers, abrasion resistant particles, corrosion resistant particles, corrosion inhibiting additives, fillers such as micas, talc, clays, and inorganic minerals, anti-oxidants, hindered amine light stabilizers, UV light absorbers and stabilizers, surfactants, flow and surface control agents, thixotropic agents, organic cosolvents, reactive diluents, catalysts, reaction inhibitors, fire retardants, and adhesion promoters.

Coatings can be applied to a wide range of articles. For example, the coating systems can be applied, for example, to automotive articles, aerospace article, industrial articles, packaging articles, wood flooring and furniture, architectural surfaces, apparel, electronics, including housings and circuit boards, glass and transparencies, and sports equipment. These articles can be, for example, metallic or non-metallic. Metallic articles include, for example, tin, steel (including electrogalvanized steel, cold rolled steel, hot-dipped galvanized steel, among others), aluminum, aluminum alloys, zinc-aluminum alloys, steel coated with a zinc-aluminum alloy, and aluminum plated steel. Non-metallic articles include, for example, polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric articles, poly(ethyleneterephthalate) (PET), polycarbonate, polycarbonate acrylonitrile butadiene styrene (PC/ABS), polyamide, wood, veneer, wood composite, particle board, medium density fiberboard, cement, stone, glass, paper, cardboard, textiles, leather, and both synthetic and natural.

Coating systems can be applied to articles found in automobile interiors, aerospace vehicle interiors, and consumer electronic products. For example, coating can be applied to articles found on instrument panels, door panels, arm rests, head rests, airbag covers, glove compartment covers, center consoles, laptops, tablets, cellular phones, and other handheld electronic devices.

Coating systems provided by the present disclosure can be used to coat an article including a surface of a vehicle. Vehicle is used in its broadest sense and includes all types of aircraft, spacecraft, watercraft, and ground vehicles. For example, a vehicle can include, aircraft such as airplanes including private aircraft, and small, medium, or large commercial passenger, freight, and military aircraft; helicopters, including private, commercial, and military helicopters; aerospace vehicles including, rockets and other spacecraft. A vehicle can include a ground vehicle such as, for example, trailers, cars, trucks, buses, vans, construction vehicles, golf carts, motorcycles, bicycles, trains, and railroad cars. A vehicle can also include watercraft such as, for example, ships, boats, and hovercraft.

Coating systems provided by the present disclosure can be used in a F/A-18 jet or related aircraft such as the F/A-18E Super Hornet and F/A-18F (produced by McDonnell Douglas/Boeing and Northrop); in the Boeing 787 Dreamliner, 737, 747, 717 passenger jet aircraft, an related aircraft (produced by Boeing Commercial Airplanes); in the V-22 Osprey; VH-92, S-92, and related aircraft (produced by NAVAIR and Sikorsky); in the G650, G600, G550, G500, G450, and related aircraft (produced by Gulfstream); and in the A350, A320, A330, and related aircraft (produced by Airbus). Coating systems provided by the present disclosure can be used in any suitable commercial, military, or general aviation aircraft such as, for example, those produced by Bombardier Inc. and/or Bombardier Aerospace such as the Canadair Regional Jet (CRJ) and related aircraft; produced by Lockheed Martin such as the F-22 Raptor, the F-35 Lightning, and related aircraft; produced by Northrop Grumman such as the B-2 Spirit and related aircraft; produced by Pilatus Aircraft Ltd.; produced by Eclipse Aviation Corporation; or produced by Eclipse Aerospace (Kestrel Aircraft).

The coatings can be applied to any suitable surface including for example, surfaces of vehicles, architectural surfaces, consumer products, electronic products, marine equipment, and industrial equipment. The coating systems particularly useful when applied to automotive interiors and consumer electronic products. For example, the coatings of the present invention can be applied to articles found on laptops, tablets, cellular phones, other handheld electronic devices, and the like. As such, the present invention further includes an electronic device or electronic component having a surface at least partially coated with the coating compositions described herein. As used herein, electronic device refers to any kind of device capable of processing data which is transmitted or received to or from any external entity. An electronic component refers to a component associated with or part of an electronic device.

The coating systems provided by the present disclosure can be used with articles and objects fabricated using additive manufacturing technologies such as three-dimensional printing. In additive manufacturing successive layers of a material are deposited to produce the three-dimensional object. Visually apparent discontinuities can result between the successive layers and can be referred to as build lines or print lines. Such visible striations or lines can be undesirable for the final product where a smooth, finished surface can be desired. Coating systems provided by the present disclosure can be applied to the printed surface to smooth the print lines and to planarize the surface such that the build lines are not visually apparent. Additional coating layers can then be applied to the first coating(s) to provide additional functionality to the coating system such as color, special surface properties, or to establish an optical property of intentional surface structures such as intentional textures or intentional patterns built into the surface. Additive manufacturing technology can be used to fabricate articles having surfaces with complex surface detail, and the coating systems provided by the present disclosure can be used to accentuate, amplify, tailor, control, augment and/or otherwise modify the optical properties of the intentional surface features. In this way, in combination with surface features fabricated using additive manufacturing methods, the coating systems provided by the present disclosure can produce desired visually and/or haptic aesthetic effects.

The coatings formed from the coating compositions of the present invention can be applied to an article by any suitable method such as, for example, by electrocoating, spraying, electrostatic spraying, dipping, rolling, and brushing. Each of the coating layers can be applied to a dry film thickness, for example, from 0.1 mil to 5 mils (2.54 μm to 127 μm), from 0.5 mil to 3 mils (12.7 μm to 76.2 μm), from 1 mil to 1.5 mils (25.4 μm to 38.1 μm), from 2 mils to 2.5 mils (50.8 μm to 63.5 μm). For example, a coating can be applied to a dry film thickness of 10 μm to 100 μm, 12 μm to 70 μm, or 15 μm to 45 μm. Each coating layer can be applied as a single coating or can be applied as multiple layers to form the coating layer. For example, a primer coating layer can include, for example, from 1 to 10 individual coating layers.

A coating composition can be applied to an article and cured to form coatings that have a soft, smooth touch or feel. For example, in certain embodiments, coatings deposited from the waterborne coating compositions described herein have been found to exhibit: a Fischer microhardness of less than 15 N/mm², or less than 10 N/mm², or less than 8 N/mm², as measured by a Fischerscope® HM2000 stylus microhardness instrument following the instruction described in the Fischerscope® HM2000 Manual (“Fischer microhardness test”); a coefficient of friction ranging from 0.01 to 0.80, or from 0.01 to 0.5, or from 0.1 to 0.3, as measured by a Dynisco Polymer Test-1055 coefficient of friction tester utilizing a felt contact according to ASTM Method D1894; and/or a surface roughness of 1 micro-inch to 60 micro-inches, or from 10 micro-inches to 40 micro-inches, or from 20 micro-inches to 30 micro-inches, as measured by a Taylor Hobson Precision Surtronic® Duo profilometer following the instruction described in the Taylor Hobson Precision Surtronic® Duo Manual (surface roughness test). As used herein, Fischer microhardness refers to the hardness of a material to deformation, “coefficient of friction” refers to the ratio of the force that maintains contact between an object and a surface and the frictional force that resists the motion of the object, and surface roughness refers to the texture of a surface such as the texture of a surface of a coating that is quantified by the vertical deviations of the surface from its ideal form.

In addition to a soft feel, coatings can exhibit good chemical and mechanical resistance. For example, coatings can resist 50 double-rubs of methyl ethyl ketone (MEK) at a dry film thickness of 50 μm in accordance with ASTM D5402. The coatings can withstand, for example, more than 50 cycles of an abrasive medium at a dry film thickness of 50 μm in accordance with ASTM F2357.

An exterior coating can exhibit good stain resistance. For example, coatings formed from the coating compositions described herein have been found to exhibit a ΔE of less than 20, less than 15, less than 12, less than 10, less than 8, less than 6, less than 4, less than 2, or less than 1 for mustard and lipstick stains after at least 168 hours of exposure. In addition, coatings formed from the coating compositions described herein have also been found to exhibit a ΔE of less than 3, less than 2, or less than 1 for sun screen, hand lotion, coffee, ketchup, stamp ink, cola, and sebum stains after at least 168 hours of exposure. The ΔE values were determined by a GretagMacBeth Color-Eye® 2145 Spectrophotometer with a cool white fluorescent light source. The ΔE value is based on the CIE94 color system using L*a*b* coordinates, and, as used herein, refers to the difference between the color of unstained and stained coating samples. The ΔE value is measured using the following method: (1) apply a coating to an article using a coating composition described herein; (2) measure the color of the unstained coated article; (3) apply a substance such as those described above to induce staining on the coating; (4) after a certain period of time, such as 168 hours of exposure, gently wipe the staining substance off of the coated sample with isopropanol or a soap solution; and (5) calculate the DE value from the color change between the unstained coating and the stained coating. The lower the DE value exhibited by the coating, the greater the stain resistance provided by the coating. The described method is also referred to as the “staining test method.”

Thus, the coating compositions described herein can be applied to an article to form coatings that have a soft touch, good stain resistance, and other properties desired in a coating.

Coating systems provided by the present disclosure can meet the requirements of aerospace interior coatings including aerospace specifications pertaining to flammability, smoke, and toxicity.

### EXAMPLES

Embodiments provided by the present disclosure are further illustrated by reference to the following examples, which describe certain coatings provided by the present disclosure and uses of such coatings. It will be apparent to those skilled in the art that many modifications, both to materials, and methods, may be practiced without departing from the scope of the disclosure.

### Example 1

### Textured Simulated Leather Test Panels

Test panels having a textured simulated leather surface were prepared by three-dimensional printing.

Ultem® 9085 (polyetherimide thermoplastic available from Stratasys, Inc.) test panels were fabricated by three-dimensional printing and comprises a surface having a simulated leather texture. The leather texture features were from about 50 μm to 150 μm above the nominal surface of the test panel. The panels were cleaned and scuffed with SU4901 (Step 1 of plastic adhesion system; PPG Industries, Inc.). The panels were then wiped with SU4902 containing plastic adhesion aides. After drying, the panels were coated with an aerosol plastic adhesion promoter (SUA4903). After the adhesion promoter coating was dry, two coats (˜1 mil (25.4 μm) dry/coat) of a 2K urethane-based primer (ECP15, Envirobase® primer surfacer; PPG Industries, Inc.) were applied using a 3M Accuspray® HVLP fitted with a 1.8 mm nozzle. After drying the primer coating, additional coating layers were applied.

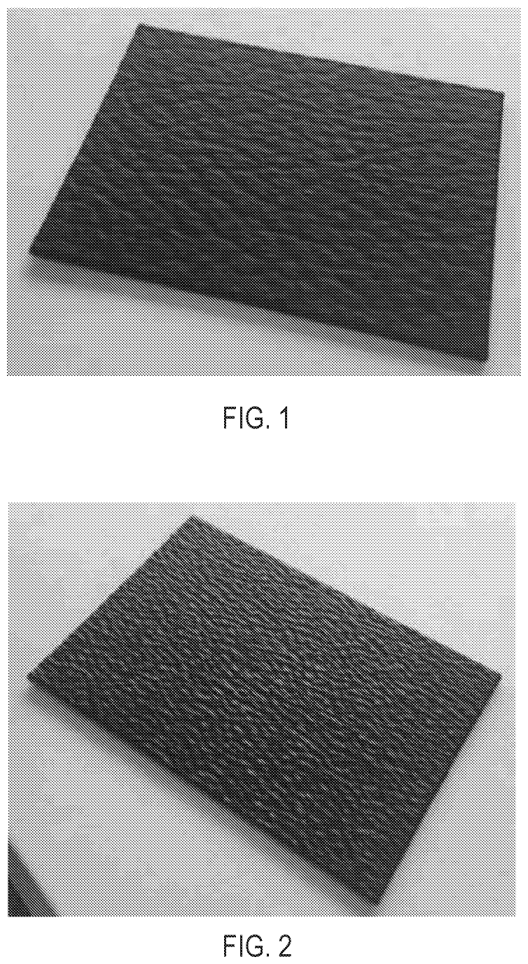

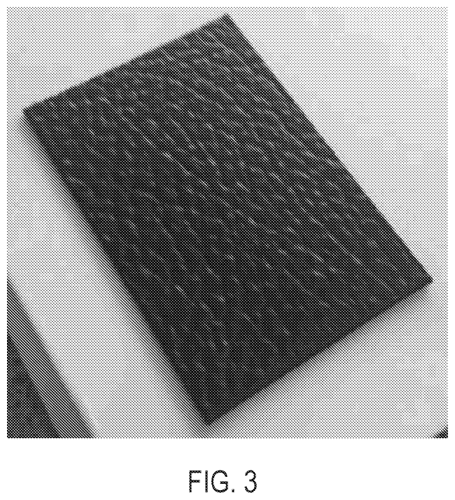

To prepare black panels having a leather-like textured surface, two coats of Envirobase® Mazda Grey basecoat (˜0.1 mils (2.54 μm) dry/coat; PPG Industries, Inc.) were applied using a SATAjet® 4000 B HVLP fitted with a WSB nozzle. After the basecoat was dry, two coats (˜1 mil (25.4 μm) dry/coat) of D8115 (Global® matte clearcoat, PPG Industries, Inc.) were applied over the basecoat using a SATAjet® 5000 B RP fitted with a 1.3 mm nozzle at a pressure of 25 psi (172 kPa). The panels were dried at room temperature (25° C.). Examples of the coated leather-textured black panels are shown in FIGS. 1-3.

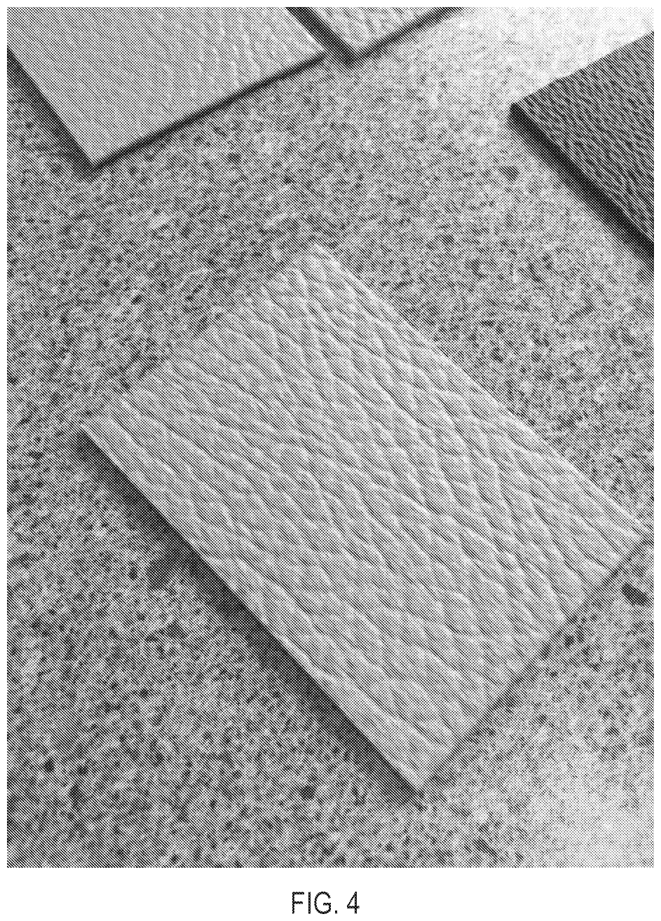

To prepare white panels having a leather-like textured surface, one coat of ECS21 sealer (1 mil (25.4 μm) dry/coat, PPG Industries, Inc.) was applied using a 3M Accuspray® HVLP fitted with a 1.8 mm nozzle. After the sealer was dry, two coats of GM 8624 White Envirobase® basecoat (˜0.1 mils (2.54 μm) dry/coat; PPG Industries, Inc.) were applied using a SATAjet® 4000 B HVLP fitted with a WSB nozzle. After the basecoat was dry, two coats (˜1 mil (25.4 μm) dry/coat) of D8115 (Global® matte clearcoat; PPG Industries, Inc.) were applied over the basecoat using a SATAjet® 5000 B RP fitted with a 1.3 mm nozzle at a pressure of 25 psi (172 kPa). The panels were then allowed to dry at room temperature (25° C.). An example of a coated leather-textured white panel is shown in FIG. 4.

### Example 2

### Simulated Wood-Grain Test Panel

Test panels having a simulated wood grain appearance were prepared by three-dimensional printing.

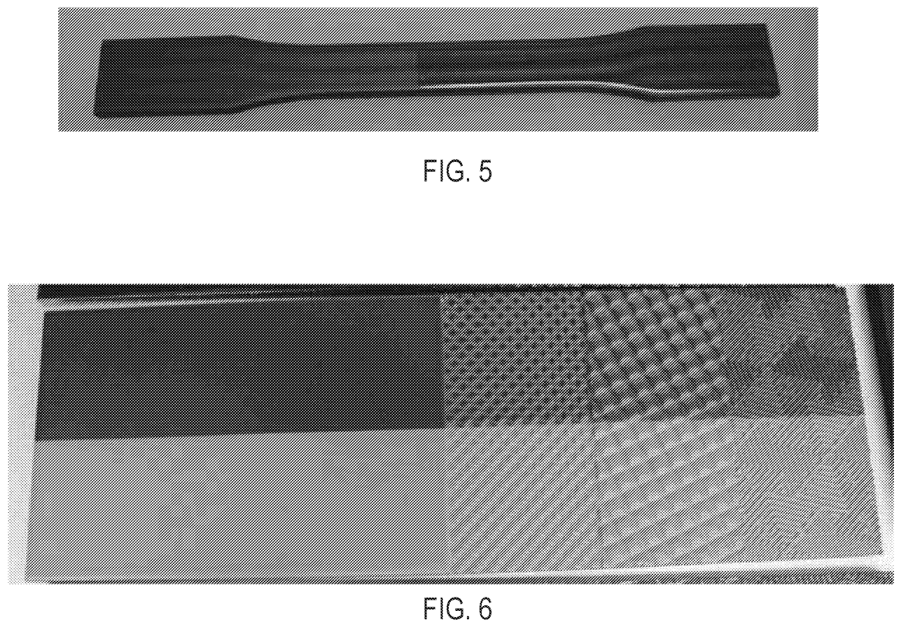

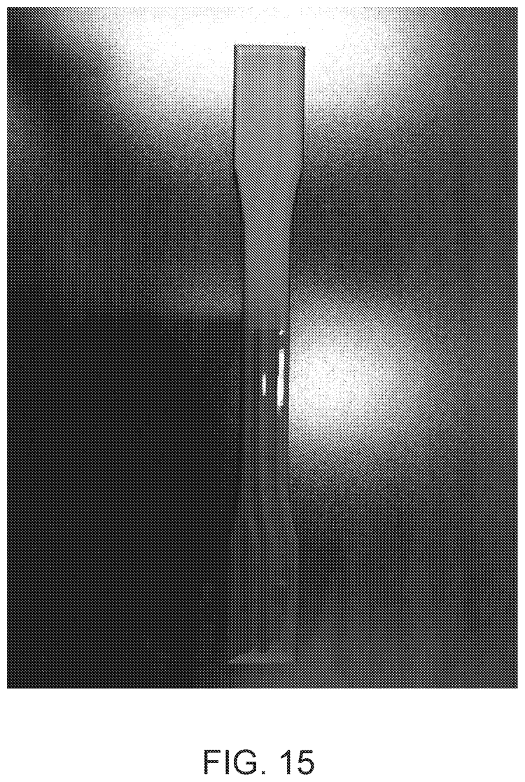

The test panels were coated with a red pigmented base coat, a mid-coating having a special effects Andaro pigment, and a top coat. A photograph of the wood grain panel is shown in FIG. 5, and shows surfaces with a portion having a matte-finish topcoat (left) and a clear gloss topcoat (right). In the view shown in FIG. 5, the contrast of the wood grain is accentuated. Another view is shown in FIG. 15 in which the angle of the light in combination with the glossy clear topcoat accentuates the three-dimensional profile of the wood grain.

### Example 3

### Textured Test Panels

Polycarbonate/ABS test panels having sections with different intentional surface topographies were fabricated using three-dimensional printing. The test panels were coated with various refinish coating systems that included a primer coating, a sealer, a basecoat, a mid-coat, and a topcoat.

The test panels were cleaned and scuffed with SU4901 (Step 1 of plastic adhesion system; PPG Industries, Inc.). The cleaned test panels were then wiped with SU4902, which contained plastic adhesion aides. After drying, the test panels were coated with an aerosol plastic adhesion promoter (SUA4903; PPG Industries, Inc.). After the adhesion promoter was dry, two coats (˜1 mil (25.4 μm) dry/coat) of ECP15 (Envirobase® primer surfacer; PPG Industries, Inc.) were applied over the adhesion promoter layer. The test panels were then baked at 60° C. for 30 min and then cooled and gently abraded with 320P grit. An additional four coats (˜1 mil (25.4 μm) dry/coat) of ECP15 was applied to the non-textured side and the test panels baked and then abraded as before. Following this procedure, the print lines were no longer visible. Two coats (˜1 mil (25.4 μm) dry/coat) of ECS25 (Envirobase® sealer; PPG Industries, Inc.) were applied and then flash-dried for 30 min.

Three layers of EHP 407 (˜0.1 mils (2.54 μm) dry/coat) basecoat (Envirobase® high performance) were then applied over the sealer. Two coats of DC4000 (˜1.2 mils (30.5 μm) dry/coat) (Deltron® glamour clearcoat; PPG Industries, Inc.) was applied to the non-textured side of the test panel. After applying the clearcoat, the test panels were baked for 30 min at 60° C. and then abraded with 800P grit sandpaper. Two coats (˜1 mil (25.4 μm) dry/coat) of D8115 (Global®matte clearcoat, PPG Industries, Inc.) were then applied to the panels.

FIGS. 6-7 show photographs of the coated textured test panels.

Red panels (FIG. 8) were coated with a tinted clearcoat having a Vibrance® red tint (VM4350 in DC4000; PPG Industries, Inc.). After the tinted clearcoat was applied, one coating (˜1 mil dry) of either a DC4000 clearcoat or a D8115 matte coating was applied over the tinted clearcoat.

ECP15 was applied using a SATAjet® 100 BF HVLP with 1.7 mm nozzle. ECS25 was applied using a SATAjet® 100 BF HVLP with 1.4 mm nozzle. The Envirobase® EHP 407 basecoat was applied using a SATAjet® 4000 B HVLP fitted with a WSB nozzle. The tinted clearcoat was applied using a Devilbiss TEKNA® Pro Lite fitted with a 1.3 mm nozzle and a TE20 air cap. All coatings were applied at a pressure of about 29 psi (200 kPa). Matte and gloss clearcoats were applied using a SATAjet® 5000 B RP fitted with a 1.3 mm nozzle at a pressure of 25 psi (172 kPa).

A summary of the coatings on the test panels is provided in Table 1.

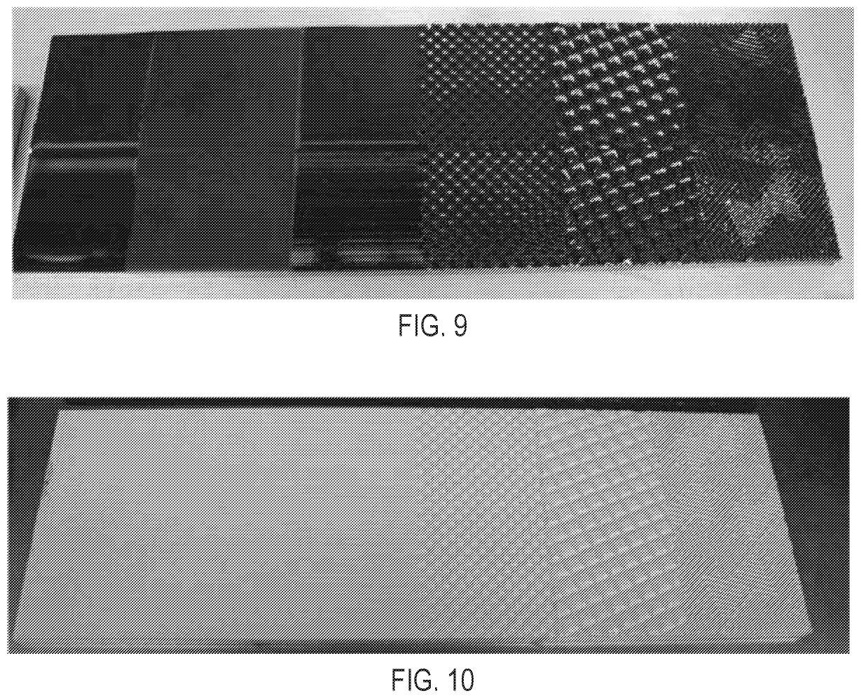

TABLE 1
Coated textured test panels.

| Coating | FIG. 6 | | FIG. 7 | | FIG. 8 | | FIG. 9 |
|---|---|---|---|---|---|---|---|
| Layer | Top | Bottom | 2 Top | 2 Bottom | 3 Top | 3 Bottom | 4 |
| Primer | ECP 15¹ | ECP 15 | ECP 15 | ECP 15 | ECP 15 | ECP 15 | ECP 15 |
| Sealer | ECS25² | ECS25 | ECS25 | ECS25 | ECS25 | ECS25 | ECS25 |
| Basecoat | EHP | EHP | Interior | Crystallance | Ruby | Ruby | EHP |
| | T407³ | T407 | Gray | Smoking | Red⁸ | Red | T407 |
| | | | | Gun⁷ | | | |
| Mid-coat | — | Interior | — | — | — | Red | — |
| | | Gray⁵ | | | | Andaro⁹ | |
| Topcoat | DC4000⁴ | D8115 | D8115 | DC4000 | D8115 | DC4000 | DC4000 |
| | | Matte⁶ | Matte | | Matte | | D8115 |
| | | | | | | | Matte |

¹ECP15; polyurethane primer, available from PPG Industries Inc.
²ECS25; polyurethane sealer coating, available from PPG Industries Inc.
³EHP T407; acrylic latex-based coating, available from PPG Industries Inc.
⁴DC4000; polyurethane-based gloss clearcoat, available from PPG Industries Inc.
⁵Interior Gray.
⁶D8115 Matte; polyruethnae-based coating having a matte finish, available from PPG Industries Inc.
⁷Crystallance ® Smoking Gun; Vibrance ® Collection pigment in DC4000 polymethane-based gloss clearcoat, available from PPG Industries Inc.
⁸Vibrance ®; Pigment VM4350 in DC4000 polyurethane-based gloss clearcoat, available from PPG Industries Inc.

### Example 4

### Weathering Test

The optical quality of the textured test panels of Example 3 were evaluated following exposure to cycles of water and light according to SAE J2527 (weathering test). Samples were placed in a weathering chamber for a total testing time of 6,000 hours and evaluated at 1,000-hour intervals. During the light cycles the weathering chamber was set at a black panel temperature of 70° C., a chamber temperature of 47° C., and a relative humidity of 50% RH. Samples were irradiated with a UV source having a 340 nm cut-off and an intensity of 0.55 W/cm². During the dark cycles the weathering chamber was set at 38° C. and a relatively humidity of 95% RH. The exposure conditions were characterized by four phases. Phase 1 was a dark cycle lasting for 60 min, with no irradiation and with water spray. In Phase 2, which lasted for 60 min, the samples were exposed to 1,320 Joules with the water spray off. In Phase 3, lasting for 60 min, the samples were exposed to 660 Joules with water spray. In Phase 4, lasting for 60 min, the samples were exposed to 1,980 Joules with the water spray off.

The results are presented in Table 2 and Table 3.

TABLE 2
Change in optical properties of coatings on ABS test panels following weathering.

| Sample | Paint | Δ Haze | Δ 60° Gloss | 45° Δ L | Δ a | Δ b | Δ E |
|---|---|---|---|---|---|---|---|
| PC ABS | Brown | 45 | −0.5 | −0.47 | −0.06 | −0.02 | 0.47 |
| Smooth | Grey Gloss | −2.1 | −0.4 | −0.04 | −0.1 | −0.2 | 0.23 |
| | Red Gloss | 286.2 | −6.1 | −0.36 | −0.15 | −0.09 | 0.40 |
| | Red Matte | −0.2 | −0.5 | 0.54 | −1.55 | −1.16 | 2.01 |
| | Black | −3.8 | −0.6 | 3.87 | −0.02 | 0.1 | 3.87 |
| | Grey Matte | −3.6 | −0.6 | 0.48 | −0.08 | −0.26 | 0.55 |
| PC ABS | Brown | −22.4 | −2 | −3.1 | 0.56 | 3.83 | 4.96 |
| Bubbles | Grey Gloss | −1.2 | −0.1 | −0.03 | 0.03 | −0.01 | 0.04 |
| | Red Gloss | −22.7 | −2 | 4.31 | −4.31 | −3.12 | 6.85 |
| | Red Matte | −2.1 | −0.1 | −0.78 | −1.52 | −0.99 | 1.97 |
| | Black | −13.6 | −1.4 | −1.09 | −0.14 | 0.4 | 1.17 |
| | Grey Matte | −15.8 | −1.7 | 1.39 | −0.07 | −0.12 | 1.40 |
| PC ABS | Brown | −2.7 | −0.3 | −7.96 | 1.09 | 4.85 | 9.38 |
| Small | Grey Gloss | −1.2 | −0.1 | −0.3 | −0.05 | −0.04 | 0.31 |
| Checks | Red Gloss | −1.4 | −0.2 | 7.24 | −10.35 | −10.39 | 16.36 |
| | Red Matte | −0.3 | −0.1 | −0.12 | −0.03 | −0.15 | 0.19 |
| | Black | −2.9 | −0.3 | 22.08 | −0.22 | −2.44 | 22.22 |
| | Grey Matte | −2.2 | −0.2 | 1.42 | 0.14 | −0.13 | 1.43 |
| PC ABS | Brown | 1 | −3.3 | −2.25 | 0.13 | 0.53 | 2.31 |
| Large | Grey Gloss | −0.3 | −0.2 | −0.31 | −0.01 | −0.03 | 0.31 |
| Checks | Red Gloss | 0.7 | −1.1 | 1.99 | −2.45 | −0.06 | 3.16 |
| | Red Matte | −0.9 | 0.6 | 2.12 | −0.43 | 0.09 | 2.16 |
| | Black | 4.3 | 0.2 | 8.85 | −0.2 | −1.13 | 8.92 |
| | Grey Matte | 1.2 | −0.1 | −0.72 | −0.06 | 0.08 | 0.73 |

TABLE 3
Change in optical properties of coatings on Ultem ® 9085
test panels following weathering.

| Sample | Paint | Δ Haze | Δ 60° Gloss | 45° Δ L | Δ a | Δ b | Δ E |
|---|---|---|---|---|---|---|---|
| Ultem ® | Brown | −60 | 1.8 | −0.11 | 0.09 | 0.16 | 0.214 |
| 9085 | Grey Gloss | −0.8 | −0.3 | 0.14 | −0.06 | −0.13 | 0.20 |
| smooth | Red Gloss | −2.7 | 0.7 | −0.8 | −0.89 | −0.93 | 1.52 |
| | Red Matte | 1.9 | −0.2 | 1.89 | −1.05 | −1.14 | 2.44 |
| | Black | −2.7 | −0.5 | 1.37 | 0.04 | −0.06 | 1.37 |
| | Grey Matte | −2.8 | −0.6 | 0.29 | −0.07 | −0.24 | 0.38 |
| Ultem ® | Brown | −0.9 | −0.1 | 2.63 | 0.2 | 0.4 | 2.67 |
| 9085 | Grey Gloss | 1 | 0.3 | −2.75 | −0.13 | −0.33 | 2.77 |
| hexagons | Red Gloss | −2.4 | 1.8 | −7.44 | 5.87 | 2.57 | 9.82 |
| | Red Matte | −3.7 | 0.2 | 1.06 | −5.21 | −2.89 | 6.05 |
| | Black | −1 | 2.1 | −16.15 | −0.25 | 1.19 | 16.20 |
| | Grey Matte | −6.7 | 0.4 | −14.91 | −0.03 | −1.4 | 14.98 |
| Ultem ® | Brown | 19.5 | 1.7 | −32.3 | 4.4 | 12.8 | 35.02 |
| 9085 Small | Grey Gloss | 3.3 | −0.9 | 0.1 | −0.22 | 0.11 | 0.26 |
| Checks | Red Gloss | 11.7 | 1.5 | −9.28 | 13.13 | 3.62 | 16.48 |
| | Red Matte | 0.3 | 0.6 | −0.45 | −4.05 | −1.3 | 4.28 |
| | Black | 18.5 | 2.9 | −33.45 | 0.88 | 4.24 | 33.73 |
| | Grey Matte | 17.2 | 1.8 | −26.71 | 0.22 | 1.4 | 26.75 |
| Ultem ® | Brown | 51.7 | 3.5 | −13.39 | 1 | 2.58 | 13.67 |
| 9085 Large | Grey Gloss | 2.2 | 0.4 | 0.94 | −0.09 | −0.24 | 0.97 |
| Checks | Red Gloss | 2.2 | 0.1 | −2.64 | 1.98 | 8.98 | 9.57 |
| | Red Matte | −2.1 | −0.1 | 1.46 | −0.98 | −0.02 | 1.76 |
| | Black | 45.9 | 4 | −11.92 | 0.32 | 1.36 | 12.00 |
| | Grey Matte | 3.7 | 0 | −1.16 | −0.2 | 0.18 | 1.19 |

The color difference was evaluated based on CIE L*a*b coordinates, where ΔL refers to the difference in lightness/darkness, Aa refers to the difference in red/green coordinate, Ab refers to the difference in yellow/blue coordinate, and ΔE is the total color difference (ΔL²+Δa²+Δb²)^{1/2}.

### Example 5

### Textured Test Panels with Automotive Refinish Coating

A textured test panel was prepared with a standard automotive refinish coating. The coating system included a primer coating (CMPP3700A; PPG Industries, Inc.), a white basecoat (DBC 930774/1; PPG Industries, Inc.), a transparent mid-coat (DBC930774/2; PPG Industries, Inc.), and a clearcoat (TKU2000CS; APAD Flex 2K, PPG Industries, Inc.). The coating layers were applied at thicknesses and using methods similar to those described in Example 4. The applied coatings were baked from 30 min at 80° C.

FIG. 10 shows a photograph of the textured test panel with a standard automotive refinish applied to the entire surface.

### Example 6

### Soft-Touch Test Panels

Test panels were prepared having a soft-touch surface coating. Ultem® 9085 panels were prepared in tan, black, and medium gray color. Each panel had three coatings. The first coating (primer) was from 15 μm to 20 μm thick and included a tan, black, or medium gray pigment. The second layer (basecoat) was from 10 μm to 20 μm thick and included a tan, black, or medium gray pigment. The third layer (soft-touch) was a 50 μm to 60 μm thick soft-touch clearcoat. The coatings were baked at from 60° C. to 80° C. for from 6 h to 8 h.

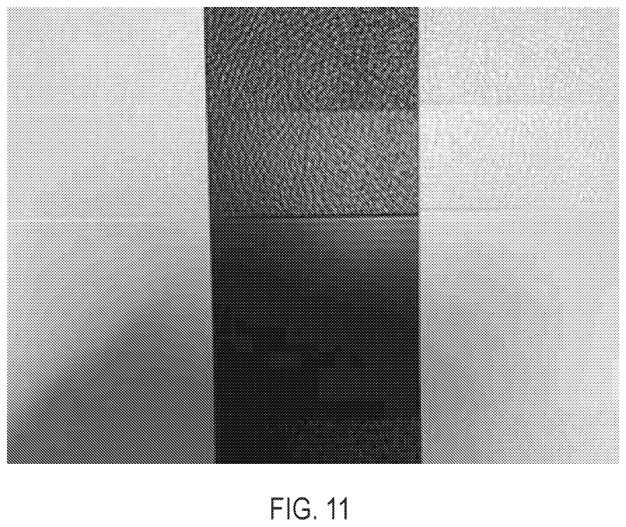

FIG. 11 shows a photograph of the panels. The upper and lower portions of the textured portion of the test panels included a different soft-touch topcoat.

### ASPECTS OF THE INVENTION

The invention is further defined by the following aspects.

Aspect 1. A coated substrate, comprising: a substrate comprising a surface, wherein the surface comprises: a plurality of first topographical features characterized by a first height; and a plurality of second topographical features having a second height, wherein the second height is greater than the first height; and a coating system overlying the surface, wherein the coating system comprises a first coating layer configured to visually hide the plurality of first topographical features.

Aspect 2. The coated substrate of aspect 1, wherein, the substrate is fabricated using additive manufacturing; and the plurality of first topographical features comprise print lines.

Aspect 3. The coated substrate of any one of aspects 1 to 2, wherein the plurality of second topographical features comprise an intentional surface topography.

Aspect 4. The coated substrate of aspect 3, wherein the intentional surface topography comprises a pattern, a texture, or a combination thereof.

Aspect 5. The coated substrate of any one of aspects 1 to 4, wherein, the plurality of first topographical features are characterized by a first height; the plurality of second topographical features is characterized by a second height; and the second height is greater than the first height.

Aspect 6. The coated substrate of any one of aspects 1 to 5, wherein the first coating layer is characterized by a thickness that is within +1-20% the first height.

Aspect 7. The coated substrate of any one of aspects 1 to 6, wherein the first coating layer is configured to planarize the surface.

Aspect 8. The coated substrate of any one of aspects 1 to 7, wherein the first coating layer comprises a primer coating.

Aspect 9. The coated substrate of aspect 8, wherein the primer coating layer comprises a urethane-based primer coating or an epoxy-based primer coating.

Aspect 10. The coated substrate of aspect 8, wherein the primer coating meets the requirements of aerospace flammability, smoke, and toxicity specifications.

Aspect 11. The coated substrate of any one of aspects 1 to 10, wherein the coating system comprises two or more second coating layers.

Aspect 12. The coated substrate of aspect 11, wherein the two or more second coating layers are configured to establish optical properties of the plurality of second topographical features.

Aspect 13. The coated substrate of aspect 12, wherein the optical properties comprise visual properties.

Aspect 14. The coated substrate of any one of aspects 11 to 13, wherein the two or more second coating layers are configured to accentuate the plurality of second topographical features.

Aspect 15. The coated substrate of any one of aspects 11 to 14, wherein the first coating layer comprises a primer coating, and the two or more second coating layers comprise a basecoat layer, a mid-coat layer, a pigment layer, a topcoat layer, an exterior coating layer, or a combination of any of the foregoing.

Aspect 16. The coated substrate of any one of aspects 11 to 15, wherein at least one of the two or more second coating layers comprises a special effects pigment.

Aspect 17. The coated substrate of any one of aspects 11 to 16, wherein the two or more second coating layers comprises an exterior haptic coating.

Aspect 18. The coated substrate of aspect 17, wherein the haptic coating comprises a soft-touch coating.

Aspect 19. The coated substrate any one of aspects 1 to 18, wherein the substrate comprises a thermoplastic, a thermoset, a metal, or a combination of any of the foregoing.

Aspect 20. The coated substrate of any one of aspects 1 to 19, wherein the substrate comprises polycarbonate, acrylonitrile butadiene styrene, polyetherimide, polyurethane, polyurea, or a combination of any of the foregoing.

Aspect 21. The coated substrate of any one of aspects 1 to 20, wherein additive manufacturing comprises three-dimensional printing.

Aspect 22. The coated substrate of any one of aspects 1 to 21, wherein the coating system comprises a primer coating overlying the substrate, a basecoat overlying the primer coating, and a haptic coating overlying the basecoat.

Aspect 23. The coated substrate of any one of aspects 1 to 22, wherein the coating system comprises a coating layer comprising a special effects pigment.

Aspect 24. The coated substrate of any one of aspects 1 to 23, wherein the substrate comprises a metal; and the coating systems comprises a two-layer electrocoat system.

Aspect 25. A vehicle comprising the coated substrate of any one of aspects 1 to 24.

Aspect 26. The vehicle of aspect 25, wherein the vehicle is an aerospace vehicle.

Aspect 27. A multilayer coating system comprising: a first coating layer, wherein, the first coating layer is configured to visually planarize a surface; and the surface comprises a plurality of intentional topographical features; and one or more second coating layers overlying the first coating layer, wherein the one or more coating layers is configured to establish an optical property of the plurality of intentional topographical features.

Aspect 28. The multilayer coating system of aspect 27, wherein the first coating layer comprises a primer coating.

Aspect 29. The multilayer coating system of any one of aspects 27 to 28, wherein the one or more second coating layers comprises a basecoat layer, a mid-coat layer, a topcoat layer, an exterior coating layer, or a combination of any of the foregoing.

Aspect 30. The multilayer coating system of any one of aspects 27 to 29, wherein at least one of the one or more second coating layers comprises a special effects pigment.

Aspect 31. The multilayer coating system of any one of aspects 27 to 30, wherein the one or more second coating layers comprises a haptic coating.

Aspect 32. A surface comprising the multilayer coating system of any one of aspects 27 to 31.

Aspect 33. The surface of claim 32, wherein the surface comprises a surface of an article fabricated using additive manufacturing.

Aspect 34. A method of coating a surface, wherein, the surface comprises: a plurality of first topographical features characterized by a first height; and a plurality of second topographical features characterized by a second height, wherein the second height is greater than the first height; and the method comprises: applying a first coating layer the surface to visually hide the first topographical features; and applying at least one second coating layer over the first coating layer to establish an optical property of the plurality of second topographical features.

Aspect 1A. A coated article, comprising: (a) an article comprising a surface, wherein, the surface comprises a plurality of low-profile features; and the plurality of low-profile features has a surface area roughness from 10 μm to 200 μm; and (b) a coating system overlying the surface, wherein the coating system comprises one or more coating layers, wherein the coated surface has a surface area roughness less than 10 μm.

Aspect 2A. The coated article of aspect 1A, wherein the coating system has an average thickness between the low-profile features that is within ±50% the surface area roughness of the plurality of low-profile features.

Aspect 3A. The coated article of any one of aspects 1A to 2A, wherein the plurality of low-profile features comprises a plurality of parallel lines.

Aspect 4A. The coated article of any one of aspects 1A to 3A, wherein the plurality of parallel features IS separated by from 10 μm to 200 μm.

Aspect 5A. The coated article of any one of aspects 1A to 4A, wherein the coating system has a total thickness that is within ±20% of the surface area roughness of the plurality of low-profile features.

Aspect 6A. The coated article of any one of aspects 1A to 5A, wherein the coated article is visually smooth.

Aspect 7A. The coated article of any one of aspects 1A to 6A, wherein the plurality of low-profile features is not visually apparent.

Aspect 8A. The coated article of any one of aspects 1A to 7A, wherein the one or more coating layers comprises from one to ten coating layers.

Aspect 9A. The coated article of any one of aspects 1A to 8A, wherein the article is fabricated using additive manufacturing.

Aspect 10A. The coated article of aspect 9, wherein additive manufacturing comprises three-dimensional printing.

Aspect 11A. The coated article of any one of aspects 1A to 10A, wherein the article comprises a surface fabricated using additive manufacturing.

Aspect 12A. The coated article of aspect 11A, wherein additive manufacturing comprises three-dimensional printing.

Aspect 13A. The coated article of any one of aspects 1A to 12A, wherein the plurality of low-profile features comprises three-dimensional printing lines.

Aspect 14A. The coated article of any one of aspects 1A to 13A, wherein the substrate further comprises a plurality of intentional topographical features, wherein the plurality of intentional topographical features has an average height that is from 400% to 1,000% the average height of the low-profile features.

Aspect 15A. The coated article of aspect 14A, wherein the plurality of low-profile features is not visually apparent, and the plurality of intentional topographical features is visually apparent.

Aspect 16A. The coated article of any one of aspects 14A to 15A, wherein the plurality of intentional topographical features is visually accentuated.

Aspect 17A. The coated article of any one of aspects 14A to 16A, wherein the coating system is configured to visually hide the plurality of parallel features.

Aspect 18A. The coated article of any one of aspects 14A to 17A, wherein the coating system is configured to enhance an optical effect of the plurality of topographical features.

Aspect 19A. The coated article of any one of aspects 14A to 18A, wherein the coating system comprises an epoxy-based coating system, a urethane-based coating system, or a combination thereof.

Aspect 20A. The coated article of any one of aspects 1A to 19A, wherein each of the one or more coating layers independently comprises a primer coating, a basecoat layer, a mid-coat layer, a pigment layer, a topcoat layer, or an exterior coating layer.

Aspect 21A. The coated article of any one of aspects 1A to 20A, wherein the one or more coating layers independently comprises a clear coat, a special-effects coating, a haptic coating, a soft-touch coating, an abrasion resistant coating, a stain resistant coating, an intumescent coating, matte-finish coating, or a combination of any of the foregoing.

Aspect 22A. The coated article of any one of aspects 1A to 21A, wherein the surface and the coated comprise an intentional three-dimensional pattern.

Aspect 23A. The coated article of aspect 22A, wherein the intentional three-dimensional pattern comprises a leather texture, a wood grain pattern, a regular pattern, an irregular pattern, or a combination of any of the foregoing.

Aspect 24A. The coated article of any one of aspects 22A to 23A, wherein the intentional three-dimensional pattern is fabricated using three-dimensional printing.

Aspect 25A. The coated article of any one of aspects 1A to 24A, wherein the article comprises a thermoplastic, a thermoset, a metal, an alloy, a composite, a ceramic, or a combination of any of the foregoing.

Aspect 26A. The coated article of any one of aspects 1A to 25A, wherein the article is electrically conductive, and the coating system comprises an electrocoating system.

Aspect 27A. The coated article of any one of aspects 1A to 26A, wherein the coated article comprises a vehicle part.

Aspect 28A. The coated article of aspect 27A, wherein the vehicle part comprises an aerospace vehicle part.

Aspect 29A. The coated article of aspect 27A, wherein the vehicle part comprises an automotive vehicle part.

Aspect 30A. The coated article of any one of aspects 1A to 30A, wherein the article is fabricated using three-dimensional printing.

Aspect 31A. A method of visually hiding a plurality of low-profile features on a surface of an article, comprising applying a coating system onto the surface to provide a coated surface, wherein, the coating system comprises one or more coating layers; and the coated surface has a surface area roughness less than 10 μm.

Aspect 32A. The method of aspect 31A, wherein the plurality of low-profile features has a surface area roughness greater than 10 μm, and the applied coating system has a total thickness that is within +1-50% the surface area roughness.

Aspect 33A. The method of any one of aspects 31A to 32A, wherein the plurality of low-profile features has a first average feature height from 10 μm to 200 μm,

Aspect 34A. The method of any one of aspects 31A to 33A, wherein the plurality of low-profile features comprises a plurality of parallel lines.

Aspect 35A. The method of any one of aspects 31A to 34A, wherein the plurality of low-profile features comprises a plurality of print lines.

Aspect 36A. The method of any one of aspects 31A to 35A, wherein the article is fabricated using additive manufacturing.

Aspect 37A. The method of any one of aspects 31A to 36A, wherein the article comprises a surface fabricated using additive manufacturing.

Aspect 38A. The method of any one of aspects 31A to 37A, further comprising abrading an applied coating layer before applying another coating layer.

Aspect 39A. A coated article prepared by the method of any one of aspects 31A to 38A.

Aspect 40A. The coated article of aspect 39A, wherein the article is fabricated using three-dimensional printing.

Aspect 41A. A method of accentuating a plurality of intentional topographical features on a surface of an article, wherein the surface comprises a plurality of low-profile features comprising applying a coating system onto the surface to provide a coated surface, wherein the low-profile features are not visually apparent on the coated surface.

Aspect 42A. The method of aspect 41A, wherein, the plurality of low-profile features has a surface area roughness from 10 μm to 200 μm; and the plurality of intentional topographical features has a second average feature height that is from 400% to 1,000% the surface area roughness of the plurality of low-profile features.

Aspect 43A. The method of any one of aspects 41A to 42A, wherein the coating system comprises one or more coating layers.

Aspect 44A. The method of any one of aspects 41A to 43A, wherein the applied coating system has a total thickness that is within +1-50% of the surface area roughness of the plurality of low-profile features.

Aspect 45A. The method of any one of aspects 41A to 44A, wherein the article comprises a surface fabricated using three-dimensional printing.

Aspect 46A. The method of any one of aspects 41A to 45A, further comprising abrading an applied coating layer before applying another coating layer.

Aspect 47A. A coated article prepared by the method of any one of aspects 41A to 46A.

Aspect 48A. The coated article of aspect 46A, wherein the article is fabricated using three-dimensional printing.

Finally, it should be noted that there are alternative ways of implementing the embodiments disclosed herein. Accordingly, the present embodiments are to be considered as illustrative and not restrictive. Furthermore, the claims are not to be limited to the details given herein and are entitled to their full scope and equivalents thereof.

1-48. (canceled)

49. A coated article, comprising:
(a) an article comprising a surface, wherein,
the surface comprises a plurality of low-profile features; and
the plurality of low-profile features has a surface area roughness from 10 μm to 200 μm; and
(b) a coating system overlying the surface, wherein the coating system comprises one or more coating layers,
wherein the coated surface has a surface area roughness less than 10 μm.

50. The coated article of claim 49, wherein the coating system has an average thickness between the low-profile features that is within ±50% the surface area roughness of the plurality of low-profile features.

51. The coated article of claim 49, wherein the plurality of low-profile features comprises a plurality of parallel lines.

52. The coated article of claim 49, wherein the plurality of parallel features is separated by from 10 μm to 200 μm.

53. The coated article of claim 49, wherein the coating system has a total thickness that is within ±20% of the surface area roughness of the plurality of low-profile features.

54. The coated article of claim 49, wherein the coated article is visually smooth.

55. The coated article of claim 49, wherein the substrate further comprises a plurality of intentional topographical features, wherein the plurality of intentional topographical features has an average height that is from 400% to 1,000% the average height of the low-profile features.

56. The coated article of claim 55, wherein the plurality of low-profile features is not visually apparent, and the plurality of intentional topographical features is visually apparent.

57. The coated article of claim 55, wherein the plurality of intentional topographical features is visually accentuated.

58. The coated article of claim 55, wherein the coating system is configured to visually hide the plurality of parallel features.

59. The coated article of claim 55, wherein the coating system is configured to enhance an optical effect of the plurality of topographical features.

60. The coated article of claim 49, wherein the coating system comprises an epoxy-based coating system, a urethane-based coating system, or a combination thereof.

61. The coated article of claim 49, wherein each of the one or more coating layers independently comprises a primer coating, a basecoat layer, a mid-coat layer, a pigment layer, a topcoat layer, or an exterior coating layer.

62. The coated article of claim 49, wherein the one or more coating layers independently comprises a clear coat, a special-effects coating, a haptic coating, a soft-touch coating, an abrasion resistant coating, a stain resistant coating, an intumescent coating, matte-finish coating, or a combination of any of the foregoing.

63. The coated article of claim 49, wherein the surface and the coated comprise an intentional three-dimensional pattern.

64. The coated article of claim 63, wherein the intentional three-dimensional pattern comprises a leather texture, a wood grain pattern, a regular pattern, an irregular pattern, or a combination of any of the foregoing.

65. The coated article of claim 63, wherein the intentional three-dimensional pattern is fabricated using three-dimensional printing.

66. The coated article of claim 49, wherein the coated article comprises a vehicle part.

67. The coated article of claim 49, wherein the vehicle part comprises an aerospace vehicle part.

68. The coated article of claim 49, wherein the vehicle part comprises an automotive vehicle part.
